(19) United States
(12) Patent Application Publication
(10) Pub. No.: US 2026/0268045 A1
(43) Pub. Date: Sep. 10, 2026

(54) METHOD TO INVERSE DESIGN MECHANICAL BEHAVIORS USING ARTIFICIAL INTELLIGENCE

(71) Applicant: The Regents of the University of California, Oakland, CA (US)

(72) Inventors: Xiaoyu ZHENG, Berkeley, CA (US); Desheng YAO, Berkeley, CA (US); Chansoo HA, Berkeley, CA (US); Mathieu BAUCHY, Los Angeles, CA (US)

(21) Appl. No.: 19/471,315

(22) PCT Filed: Mar. 29, 2024
(86) PCT No.: PCT/US2024/022177

§ 371 Date: Sep. 30, 2025

Related U.S. Application Data
(60) Provisional application No. 63/456,200, filed on Mar. 31, 2023.

(51) Int. Cl. G06F 30/27; G06F 30/17; G06F 113/10; G06F 119/14

(52) U.S. Cl. CPC G06F 30/27; G06F 30/17; G06F 2113/10; G06F 2119/14

(57) ABSTRACT

A method for rapid inverse design is disclosed which utilizes generative machine learning and additive manufacturing, which allows for metamaterial creations based on arbitrary stress-strain curves that characterize their mechanical behaviors. In embodiments, a user sketches a target compressive stress-strain curve described by a set of curve features as the input into a generative machine learning pipeline, which outputs an optimal digital design within a few seconds that, once 30 printed, will fully replicate the prescribed stress-strain curve upon compression testing. The present invention accounts for process-dependent errors from a mass-customer based printing technique and enables the rapid creation of nearly all possible stress-strain curve cases subjected to compression; and is able to achieve, exotic mechanical behavior along with high degrees of tailorability, with high fidelity between target and measured curves from 3D printed inverse-designed metamaterials.

### REFERENCE TO RELATED APPLICATIONS

The present application claims priority to and the benefit of U.S. Provisional Patent Application Ser. No. 63/456,200, filed Mar. 31, 2023, and entitled “METHOD TO INVERSE DESIGN MECHANICAL BEHAVIORS USING ARTIFICIAL INTELLIGENCE,” the entire contents of which are hereby incorporated by reference herein.

### STATEMENT OF GOVERNMENT SUPPORT

This invention was made with government support under Grant Number N00014-20-1 2504:P00001 awarded by the Office of Naval Research. The government has certain rights in the invention.

### FIELD OF INVENTION

The present invention relates to systems and methods to design and print materials with customizable architectures.

### BACKGROUND

Designing and printing metamaterials with customizable architectures enables the realization of unprecedented mechanical properties that transcend those of their constituent materials, such as negative compressibility, ultrahigh stiffness, and multi-stability. In particular, engineering materials to reproduce a particular stress-strain curve may hypothetically yield a set of specific mechanical behaviors under loading. However, existing inverse design methods and systems fail to capture the full desired behaviors due to technical challenges stemming from multiple design objectives, nonlinear behavior, and process-dependent manufacturing errors.

The intrinsic mechanical behavior of bulk materials (e.g., metals, ceramics, polymers) may be experimentally characterized by the application of force and the measurement of the resulting deformation, yielding stress-strain curves. For example, under tensile loading, the mechanical behavior of brittle materials such as ceramics may be characterized by a stress-strain curve with a linear region followed by a sharp termination and elastomers may display superelasticity, characterized by a rapidly rising concave-up stress-strain curve without a noticeable linear region. For homogenous materials such as metals, ceramics, and polymers, responses to loading are dictated by intrinsic microstructure, such as crystal structure, atomic bonding, and the size and mass of the constituent molecules/atoms, in addition to the presence of stochastic microscopic defects. As a result, classically, there is little room to tailor these materials' responses to loads besides altering the intrinsic microstructure of the base materials.

Additive manufacturing (AM) may allow mechanical properties to be tailored in ways that are impossible in bulk materials, via the microarchitecture design of three-dimensional (3D) metamaterials. Indeed, these materials can exhibit exotic properties such as negative Poisson's ratio [1-3], negative compressibility [4, 5], ultralightness and ultrastiffness, shape recoverability [6-8], and multiple stable states [9-11]. These architected materials may be able to achieve previously unattainable region in the material selection chart (e.g., so-called as Ashby charts of density vs. Young's modulus or strength) [12, 13]. Architected materials manifesting these properties have been typically designed by forward design approaches, topology optimizations [14,15] and, more recently, machine learning (ML) [16-22]. The forward approaches iteratively adjust design parameters of architected materials (such as unit cell size, wall thickness, and so forth) until measured or simulated properties satisfy prescribed design criteria, which usually require substantial prior knowledge of experienced designers. While the topology optimizations and ML-based design approaches have shown the potential to yield designs that provide some desired property values, they do not accurately capture all of the required mechanical behaviors in practice, due to nonunique response-to-design mapping and challenges in simultaneously representing a large number of variables. These design approaches are further complicated by the presence of manufacturing defects, process variabilities and uncertainties [23, 24] which necessitate substantial calibrations to account for defects in additively manufactured samples with hundreds to millions of spatial constituents as each member independently may contribute to realization of target responses [25, 26]. As a result of these challenges and defects, the actual mechanical properties of fabricated samples in conventional systems often substantially deviate from the designed extremal properties [25, 26], which, if not considered, could lead to suboptimal or catastrophic failure on application.

What is needed is a system and method to design and print metamaterials with customizable architectures that overcome these and other technical challenges.

### SUMMARY OF INVENTION

In view of the above, it is an object of the present invention to provide a method for designing and generating a target with customizable architecture including: obtaining, by a first machine learning module, a set of target stress-strain curve features characterizing a target stress-strain curve; generating a first output, by the first machine learning module trained using a first training set, based on a first query, wherein: the first query includes the set of target stress-strain curve features; the first output includes sets of digital design parameters for printing the metamaterial target using a 3D printer, wherein each of the sets of digital design parameters includes: for each cell, a cell type denoting a category of unit cell, and a characteristic angle specifying an orientation of struts of each cell in the category, and a radius-to-length ratio of an inclined strut representing the solid-to-air ratio of the unit cell; and a design lattice structure utilizing each cell; and a base material type; and a gradient; and the first training set includes a first plurality of training stress-strain curve features and respective associated design parameters sets; obtaining, by a second machine learning module, the sets of digital design parameters; obtaining, by the second machine learning module, a subset of the set of target stress-strain curve features; generating a second output, by the second machine learning module trained using a second training set, based on a second query, wherein: the second query includes the sets of digital design parameters and the subset of the set of target stress-strain curve features; the second output includes respective sets of stress-strain curve features characterizing a predicted stress-strain curve; the second training set includes a second plurality of training stress-strain curve features and respective associated design parameters sets; determining, by the second machine learning module, an optimal set of design parameters of the sets of digital design parameters; and printing or causing to print, by a 3D printer, the metamaterial target, based on the optimal set of design parameters.

It is a further object of the present invention to provide a computer system for designing and generating a target comprising one or more processors operably connected to one or more memories, the one or more memories containing computer-readable instructions, then when executed, cause the one or more processors to perform the method of: obtaining, by a first machine learning module, a set of target stress-strain curve features characterizing a target stress-strain curve; generating a first output, by the first machine learning module trained using a first training set, based on a first query, wherein: the first query includes the set of target stress-strain curve features; the first output includes sets of digital design parameters for printing the metamaterial target using a 3D printer, wherein each of the sets of digital design parameters includes: for each cell, a cell type denoting a category of unit cell, and a characteristic angle specifying an orientation of struts of each cell in the category, and a radius-to-length ratio of an inclined strut representing the solid-to-air ratio of the unit cell; and a design lattice structure utilizing each cell; and a base material type; and a gradient; and the first training set includes a first plurality of training stress-strain curve features and respective associated design parameters sets; obtaining, by a second machine learning module, the sets of digital design parameters; obtaining, by the second machine learning module, a subset of the set of target stress-strain curve features; generating a second output, by the second machine learning module trained using a second training set, based on a second query, wherein: the second query includes the sets of digital design parameters and the subset of the set of target stress-strain curve features; the second output includes respective sets of stress-strain curve features characterizing a predicted stress-strain curve; the second training set includes a second plurality of training stress-strain curve features and respective associated design parameters sets; determining, by the second machine learning module, an optimal set of design parameters of the sets of digital design parameters; and transmitting, to a 3D printer, the metamaterial target, based on the optimal set of design parameters.

### BRIEF DESCRIPTION OF THE DRAWING

The above and related objects, features and advantages of the present disclosure will be more fully understood by reference to the following detailed description of the preferred, albeit illustrative, embodiments of the present invention when taken in conjunction with the accompany figures, wherein:

FIG. 1 is a block drawing of a generative ML pipeline in accordance with embodiments of the present invention;

FIG. 1A is a schematic of a generative ML pipeline in accordance with embodiments of the present invention;

FIG. 1B depicts a graph which may be used to generate target curve features in accordance with embodiments of the present invention;

FIG. 1C is an exemplary CAD model of a lattice design generated in accordance with embodiments of the present invention;

FIG. 1D is a representative schematic of compression testing on a printed sample with design parameters generated by the machine learning method illustrated in FIG. 1A;

FIG. 1E illustrates a hypothetical example of a graph depicting a stress-strain curve following testing of a 3D printed design;

FIG. 2A illustrates a full stress-strain curve design space composed of a series of subdesign spaces in a dimensionless plot in accordance with embodiments of the present invention;

FIG. 2B illustrates example stress-strain curves in accordance with embodiments of the present invention;

FIG. 2C provides examples of architectural cells with cubic symmetry in accordance with exemplary embodiments of the present invention;

FIG. 3A depicts target and measured curves in accordance with embodiments of the present invention based on monotonic compression loadings;

FIG. 3B depicts target and measured curves in accordance with embodiments of the present invention based on cyclic compression loadings;

FIG. 3C depicts photographs of the printed samples inversely designed by the machine learning predicted design parameters for the target curves in accordance with the present invention;

FIG. 3 is a representative inverse design based on representative target stress-strain curves and experimental design validation in accordance with embodiments of the present invention;

FIG. 4A depicts the tailoring process to improve the energy absorption behavior for the architected midsole design in accordance with exemplary embodiments of the present invention;

FIG. 4B illustrates relative load distribution of the midsole during running;

FIG. 4C illustrates a photograph of a midsole sample designed and printed in accordance with exemplary embodiments of the present invention;

FIG. 4D illustrates a series of target and measured stress-strain curves of an architected shoe midsole sample designed and printed in accordance with the present invention;

FIG. 4 is an illustration of an architected show midsole design with representative stress-train curves in accordance with embodiments of the present invention; and

FIGS. 5A-5C illustrate three sets of target stress-strain curves in accordance with embodiments of the present invention;

FIGS. 5D-5F are an experimental demonstration of tailored stress-strain hysteresis loops displaying deformations at different strains in accordance with embodiments of the present invention;

FIG. 6A illustrates the overall architecture of the machine learning (ML) generative pipeline in an exemplary embodiment of the present invention;

FIG. 6B illustrates generative-surrogate model linkage in accordance with embodiments of the present invention;

FIG. 6C depicts multiple design candidates obtained from the inverse prediction module for the target curve shown in FIG. 6A in accordance with embodiments of the present invention;

FIG. 6D depicts examples of estimated curves from the fifth surrogate model in FIG. 6A in accordance with embodiments of the present invention;

FIG. 6 is an illustration of exemplary details of a ML approach used by the present invention;

FIGS. 7A and 7B depict plottable stress-strain curve paths in accordance with embodiments of the present invention;

FIGS. 8A-8C depict exemplary mechanical performance assessments of the architectural unit cells in accordance with embodiments of the present invention;

FIG. 9A depicts an example of stress-strain curve parameterized in terms of curve features in accordance with embodiments of the present invention;

FIG. 9B depicts illustrative examples 920, 930, 940, 950, 960 of the curve parameterization for several curve paths in accordance with embodiments of the present invention;

FIG. 10 depicts illustrative stress-strain capability of compound latices in accordance with embodiments of the present invention; and

FIGS. 11A and 11B depict a sequential integration strategy for compound lattice generation and training set generation in accordance with exemplary embodiments of the present invention.

### DETAILED DESCRIPTION OF THE EXEMPLARY EMBODIMENTS

The present invention relates to systems and methods to design and print target metamaterials with customizable architectures.

Embodiments of the present invention include a method for designing and generating a target with customizable architecture including: obtaining, by a first machine learning module, a set of target stress-strain curve features characterizing a target stress-strain curve; generating a first output, by the first machine learning module trained using a first training set, based on a first query, wherein: the first query includes the set of target stress-strain curve features; the first output includes sets of digital design parameters for printing the metamaterial target using a 3D printer, wherein each of the sets of digital design parameters includes: for each cell, a cell type denoting a category of unit cell, and a characteristic angle specifying an orientation of struts of each cell in the category, and a radius-to-length ratio of an inclined strut representing the solid-to-air ratio of the unit cell; and a design lattice structure utilizing each cell; and a base material type; and a gradient; and the first training set includes a first plurality of training stress-strain curve features and respective associated design parameters sets; obtaining, by a second machine learning module, the sets of digital design parameters; obtaining, by the second machine learning module, a subset of the set of target stress-strain curve features; generating a second output, by the second machine learning module trained using a second training set, based on a second query, wherein: the second query includes the sets of digital design parameters and the subset of the set of target stress-strain curve features; the second output includes respective sets of stress-strain curve features characterizing a predicted stress-strain curve; the second training set includes a second plurality of training stress-strain curve features and respective associated design parameters sets; determining, by the second machine learning module, an optimal set of design parameters of the sets of digital design parameters; and printing or causing to print, by a 3D printer, the metamaterial target, based on the optimal set of design parameters.

Embodiments of the present invention include a computer system for designing and generating a target comprising one or more processors operably connected to one or more memories, the one or more memories containing computer-readable instructions, then when executed, cause the one or more processors to perform the method of: obtaining, by a first machine learning module, a set of target stress-strain curve features characterizing a target stress-strain curve; generating a first output, by the first machine learning module trained using a first training set, based on a first query, wherein: the first query includes the set of target stress-strain curve features; the first output includes sets of digital design parameters for printing the metamaterial target using a 3D printer, wherein each of the sets of digital design parameters includes: for each cell, a cell type denoting a category of unit cell, and a characteristic angle specifying an orientation of struts of each cell in the category, and a radius-to-length ratio of an inclined strut representing the solid-to-air ratio of the unit cell; and a design lattice structure utilizing each cell; and a base material type; and a gradient; and the first training set includes a first plurality of training stress-strain curve features and respective associated design parameters sets; obtaining, by a second machine learning module, the sets of digital design parameters; obtaining, by the second machine learning module, a subset of the set of target stress-strain curve features; generating a second output, by the second machine learning module trained using a second training set, based on a second query, wherein: the second query includes the sets of digital design parameters and the subset of the set of target stress-strain curve features; the second output includes respective sets of stress-strain curve features characterizing a predicted stress-strain curve; the second training set includes a second plurality of training stress-strain curve features and respective associated design parameters sets; determining, by the second machine learning module, an optimal set of design parameters of the sets of digital design parameters; and transmitting, to a 3D printer, the metamaterial target, based on the optimal set of design parameters.

In embodiments, the one or more processors execute computer code stored in the one or more memories. In embodiments, the computer system may be local to a user, remote from the user, or both local and remote (e.g., aspects may involve cloud computing). In embodiments, the computer code may include portions written in Python. In embodiments, the computer system may have an input device such as a keyboard and mouse and an output device such as a monitor which are operably connected to the one or more processors.

In embodiments, the target stress-strain curve is a user-defined target stress-strain curve. In embodiments, the user-defined target stress-strain curve is be drawn, uploaded and/or input by a user.

In embodiments, the sets of digital design parameters is transmitted from the first machine learning module to the second machine learning module.

In embodiments, the subset of the set of target stress-strain curve features includes one or more features corresponding to load type.

In embodiments, the first machine learning module includes an inverse prediction module.

In embodiments, the second machine learning module includes a forward validation module. In embodiments, the forward validation module includes a curve type classifier and a curve feature regressor.

In embodiments, printing is based on printing parameters. In embodiments, the printing parameters include a minimum feature size and a maximum print volume of the 3D printer.

In embodiments, the base material type is selected from a list of materials.

In embodiments, the first training set includes data augmented from pristine data. In embodiments, the second training set includes pristine data. In embodiments, the second plurality of training stress-strain curve features and respective associated design parameters sets includes a subset of the first plurality of training stress-strain curve features and respective associated design parameters.

In embodiments, the generating step performed by the second machine learning module is iterated. In embodiments, the generating step is iterated based on the lack of an optimal set of design parameters. In embodiments, there may not be an optimal set of design parameters if the target stress-strain curve and the predicted stress-strain curve are too dissimilar. In embodiments, dissimilarity may be measured using a normalized root mean square error calculation.

In embodiments, the method is iterated based on, or following, testing of the target. In embodiments, iteration occurs based on testing of a printed target and/or a simulated target.

In embodiments, the target is a metamaterial target.

In embodiments, the optimal set of design parameters are the set of design parameters associated withs the lowest normalized root mean square error between the predicted stress-strain curve and the target stress strain curve.

Embodiments of the present invention include a method of training one or more neural networks for generating one or more 3d printable cells by collecting a set of training stress-strain curve features; generating a first lattice based on the simulated curve features; printing the first lattice; obtaining first test results related to the first lattice; creating a first training set comprising the simulated curve features, the first test results, and the first lattice; training a neural network in a first stage using the first training set; creating a second training set for a second stage of training comprising the first training set and second test results related to a second lattice printed after the first stage of training; and training the one or more neural networks in a second stage using the second training set.

Embodiments of the present invention include a program product for designing and generating a target with customizable architecture including: a first machine learning module configured to obtain a set of target stress-strain curve features characterizing a target stress-strain curve and to generate a first output, using a first training set, based on a first query, wherein the first query includes the set of target stress-strain curve features, the first output includes sets of digital design parameters for printing the metamaterial target using a 3D printer, wherein each of the sets of digital design parameters includes, for each cell, a cell type denoting a category of unit cell, and a characteristic angle specifying an orientation of struts of each cell in the category, and a radius-to-length ratio of an inclined strut representing the solid-to-air ratio of the unit cell, and a design lattice structure utilizing each cell, and a base material type, and a gradient, and the first training set includes a first plurality of training stress-strain curve features and respective associated design parameters sets; and a second machine learning module configured to obtain the sets of digital design parameters and a subset of the set of target stress-strain curve features, to generate a second output, using a second training set, based on a second query, wherein the second query includes the sets of digital design parameters and the subset of the set of target stress-strain curve features, the second output includes respective sets of stress-strain curve features characterizing a predicted stress-strain curve, and the second training set includes a second plurality of training stress-strain curve features and respective associated design parameters sets, and to determine an optimal set of design parameters of the sets of digital design parameters.

In embodiments, a printing module of the program product causes the metamaterial target to print a metamaterial target, based on the optimal set of design parameters.

In embodiments, the present invention offers a computer-implemented design methodology to generate printable materials with desired stress-strain curves. In accordance with embodiments of the present invention, a user provides a desired mechanical behavior, and the machine learning module in accordance with embodiments of the present invention provides as an output a design that meets the stress-strain curve associated with the desired mechanical behavior. In embodiments, the outputted design is printed, and if desired, tested to confirm that it is consistent with the desired mechanical behavior. To the extent the tested design is not sufficiently in accordance with desired mechanical behavior, the machine learning module can be provided feedback and modified to adjust accordingly.

In embodiments, the present invention employs a rapid inverse design methodology leveraging generative machine learning and additive manufacturing, which allows for metamaterial creations based on arbitrary stress-strain curves that characterize their mechanical behaviors. Specifically, a user sketches a target compressive stress-strain curve described by a set of curve features as the input into a generative machine learning pipeline, which may output an optimal digital design in a short period of time (e.g., within a few seconds) that if 3D printed, will closely replicate the prescribed stress-strain curve, within a margin of error, upon testing (e.g., compression testing). In embodiments, the present invention may account for process-dependent errors from a mass-customer based printing technique and enables the rapid creation of nearly all possible stress-strain curve cases subjected to compression. Additionally, exotic mechanical behavior along with full tailorability can be achieved, with fidelity of nearly 90% between the target and measured curves from 3D printed inverse-designed metamaterials. The present invention provides a method of generating inverse design materials that meet prescribed, spatially and temporarily dependent behaviors, bypassing manufacturing-design cycles. The disclosed method may be applied to rapid inverse design of other complex behaviors under various loading conditions, such as J-curve phenomena, impact, and magnetic and electromechanical responses with relevant training data, to name a few.

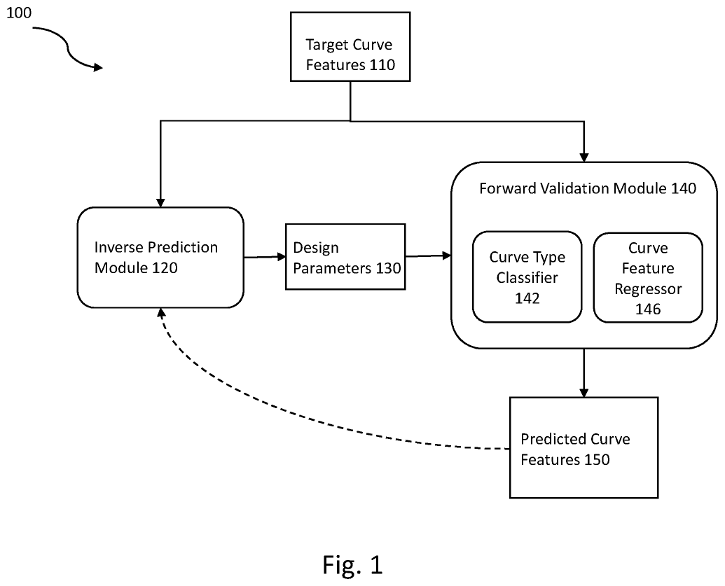

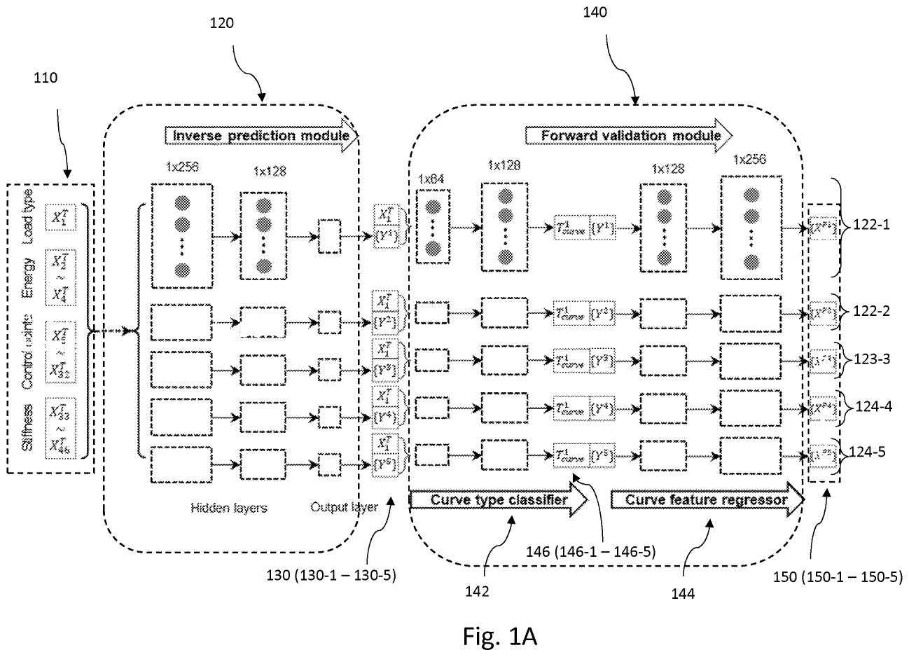

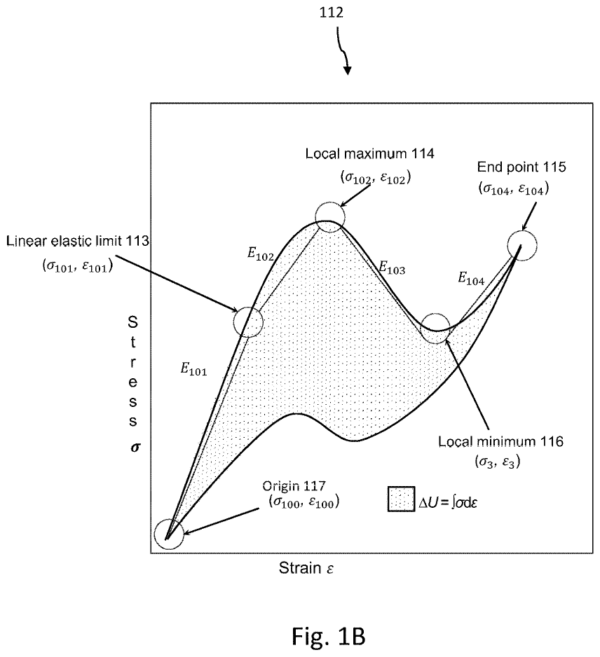

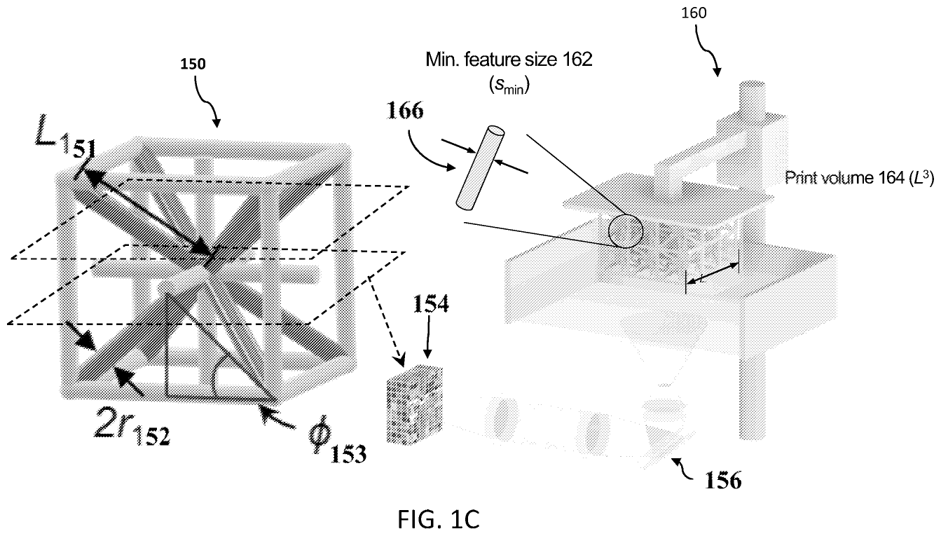

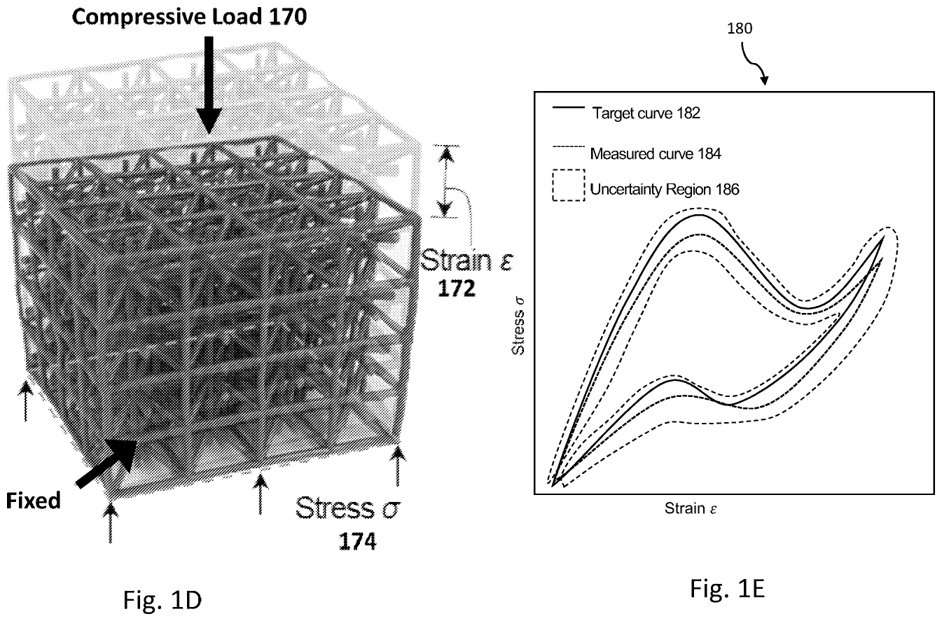

In embodiments, a machine learning module is provided which addresses the aforementioned issues. A rapid inverse design methodology is presented in accordance with embodiments of the present invention that can produce designs that replicate tailored mechanical behaviors upon loading via ML and AM while incorporating process variabilities. In embodiments, the present invention utilizes generative inverse and surrogate forward neural network (NN) models (details of the ML workflow shown in FIGS. 1, 1A), where the input comprises a user-defined stress-strain curve described by a set of curve features {X^{T}}, and fabrication parameters represented by the maximum build volume dimensions (L³) and minimum printable feature size (smin) of a given 3D printer (FIG. 1C). The output is a set of optimal design parameters {Y} (i.e., a cell type (Tcell) denoting the category of the unit cell in the training dataset, a characteristic angle (φ) specifying the orientation of struts of each cell in the category, and a radius-to-length ratio of an inclined strut (r1/L1) representing the solid-to-air ratio of the unit cell), describing a digital lattice design that, once 3D-printed and tested, will replicate the target stress-strain curve (FIGS. 1B-1E). To achieve this, a family of architectural unit cells capable of capturing distinct curve shapes under both monotonic and cyclic compressive loadings which covering a wide range of mechanical behaviors of a cellular solid is provided. In embodiments, these cells serve as building blocks for creating two separate training datasets differentiated by two distinct (brittle and flexible) polymeric base materials. In embodiments, from the training datasets, an ML pipeline (which may include multiple ML modules working together) learns the relationship between various mechanical behaviors, architecture designs, and process-dependent manufacturing errors, and generates lattice replicating the target stress-strain curve. In embodiments, the present invention may lead to an inverse design of arbitrary stress-strain curves which represent the entire mechanical responses under loading within the design space of a given polymeric material. In experimental embodiments, additional tailored mechanical behaviors can be realized by graphically modifying the local geometric features of a stress-strain curve. In contrast to the conventional design approaches discussed earlier, the present invention may allow for the rapid creation of materials with tailorable mechanical behavior while accounting for manufacturing process errors and nonlinear behavior.

### Overview of the Generative ML Approach

FIG. 1 is a block drawing of a generative ML pipeline 100 in accordance with embodiments of the present invention. In embodiments, the generative ML pipeline 100 includes an inverse prediction module 120 and forward validation module 140. In embodiments, the forward validation module includes a curve type classifier 142 and a curve feature regressor 146. In embodiments, the inverse prediction module 120 obtains a plurality of target curve features 110 (e.g., via user input or based on a target curve) and outputs design parameters 130. In embodiments, the forward validation module 140 obtains the plurality of target curve features 110 and the design parameters 130 and outputs respective predicted curve features 150.

FIG. 1A is a schematic of a generative ML pipeline in accordance with embodiments of the present invention. FIG. 1A provides a more detailed view of aspects of FIG. 1. In embodiments, the generative ML pipeline is composed of an inverse prediction module 120 and forward validation modules 140, where each module is composed of a number of (e.g., five, to give an example) distinct NN models 140 (e.g., NN models 122-1 to 122-5 (FIG. 1A)). In embodiments, each NN model in the inverse prediction module generates a set of design parameters (also referred to as “design candidates”) 130 ({Y}) (e.g., 130-1-130-5: {Y¹}, {Y²}, {Y³}, {Y⁴}, {Y⁵} of FIG. 1A) for a given target curve features (e.g., target curve features 100, {X^{T}}) used as an input. In embodiments, each respective design candidate {Y^{k}} may be described by a cell type (Tcell), characteristic angle (φ) and radius-to-length ratio (r1/L1)). In embodiments, as shown in FIG. 1A, k ranges from 1 to 5, such that there five design candidates (e.g., {Y¹}, {Y²}, {Y³}, {Y⁴}, {Y⁵} of FIG. 1A). In embodiments, there may be more than five design candidates. In embodiments, there may be less than five design candidates.

In embodiments, the target curve features include a load type

$$( e . g . , {X}_{1}^{T} of FIG . 1 A ) ,$$

energy

$$( e . g . , {X}_{2}^{T} \sim {X}_{4}^{T} of FIG . 1 A ) ,$$

control points defining the curve

$$( e . g . , {X}_{5}^{T} \sim {X}_{32}^{T} of FIG . 1 A ) ,$$

and curve stiffness

$$( e . g . , {X}_{33}^{T} \sim {X}_{46}^{T} of FIG . 1 A ) ,$$

to give a few examples. In embodiments, the target curve features are user-defined.

Referring now to FIG. 1B, FIG. 1B depicts a graph which may be used to generate target curve features in accordance with embodiments of the present invention. In embodiments, the target curve features are derived from curves of a stress-strain chart (e.g., chart 112, to give an example) which may be defined by a linear elastic limit 113, a local maximum 114, an end point 115, local minimum 116 and an origin 117). In embodiments, the stress strain chart 112 is generated based on a user drawing. In embodiments, the curve is generated based on parameters entered by a user.

Referring back to FIG. 1A, in embodiments, the forward validation module 140 includes a curve type classifier 142 and a curve feature regressor 144. In embodiments, the curve type classifier 142 and curve features regressor 144 are sub-modules of the forward validation module 140. In embodiments, the curve type classifier 142 generates a plurality of predicted target curve features (e.g., target curve features 146: 146-1-146-5). In embodiments, the design candidates and predicted target curve features are then obtained by a curve feature regressor (e.g., curve feature regressor 144) of the forward validation module 140 to estimate responses 150 ({X^{Pk}}) of the design candidates (e.g., responses 150-1-150-5: {X^{P1}}, {X^{P2}}, {X^{P3}}, {X^{P4}}, and {X^{P5}} of FIG. 1A). In the embodiment illustrated by FIG. 1A, each of these responses {X^{Pk}} is compared to a target curve feature {X^{T}} for selection of the optimal design (e.g., by the forward validation module 140). In embodiments, a design for a 3D printed model is generated based on the selected optimal design.

FIG. 1C is an exemplary CAD model of a lattice design generated in accordance with embodiments of the present invention. For example, in embodiments a lattice design (e.g., lattice design 150) may be generated based on one or more design candidates (e.g., design candidates 130 of FIG. 1A). In embodiments, the generated lattice design has struts of a given length, diameter, and angle (e.g., length L₁₅₁, a diameter of 2r₁₅₂, and an angle φ₁₅₃). In embodiments, the lattice design 150 is part of a larger design 154. In embodiments, the 3D printing system (e.g., 3D printer 160) may print one or more lattice structures (e.g., a lattice structure including lattice 150 or design 154, to give an example) based on instructions/light 156. In embodiments, the 3D printing system has specific fabrication parameters (e.g., minimal feature size 162 (sₘᵢₙ) which may set minimum dimensions of a strut 166, and maximum printing volume 164 (L³)).

FIG. 1D is a representative schematic of compression testing on a printed sample with design parameters generated by the machine learning method illustrated in FIG. 1A. In embodiments, a compressive load 170 is applied, and strain 172 and stress 174 measurements are taken.

FIG. 1E illustrates a hypothetical example of a graph depicting a stress-strain curve following testing of a 3D printed design. In embodiments, the graph 180 includes a target curve 180, which may correspond to the target curve features 110, a measured curve 184, which depicts a curve generated based on testing such as the compressive testing (e.g., as depicted in FIG. 1D), as well as an uncertainty region 186 based on the measured curve 174. In embodiments, the uncertainty region represents the process variability obtained through the testing of multiple samples.

This embedded approach solves the nonunique response-to-design mapping challenge in inverse design (e.g., several micro-architectural features may give the same output curves, thereby increasing the cost function of training the model). The present invention addresses the “one-to-many” issue associated with the target parameters.

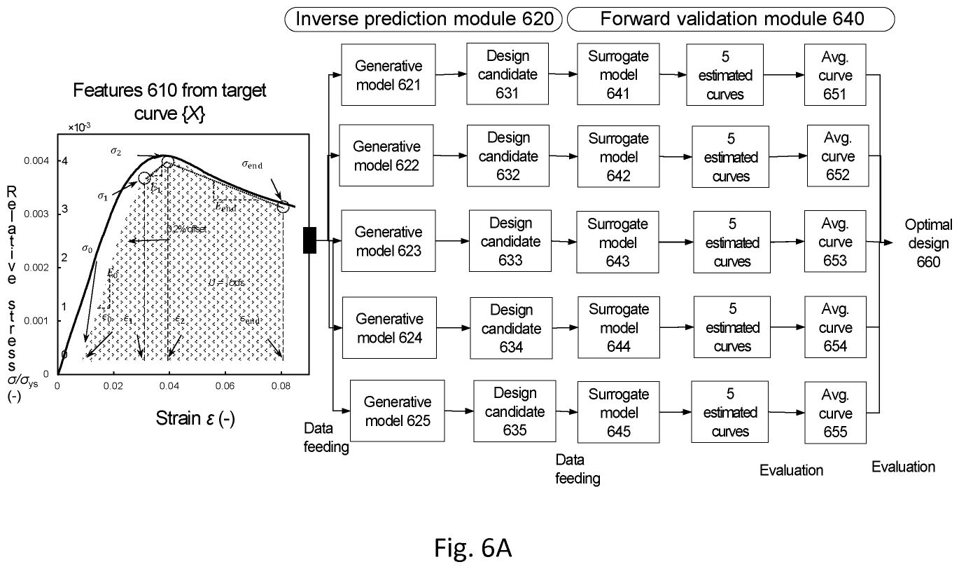

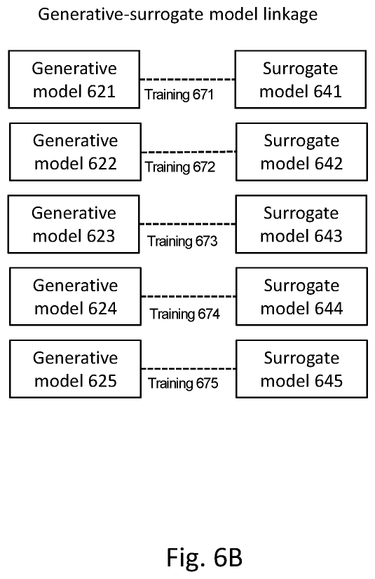

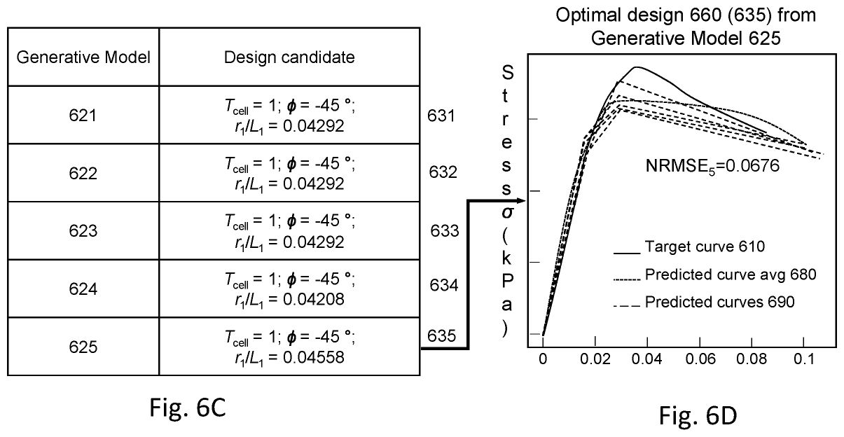

FIGS. 6A and 6B illustrate exemplary details of a ML approach in accordance with embodiments of the present invention.

FIG. 6A illustrates the overall architecture of the machine learning (ML) generative pipeline in an exemplary embodiment of the present invention. In embodiments, the ML generative pipeline includes (i) a forward validation module 640 and (ii) an inverse prediction module 620. In embodiments, the forward validation module 640 consists of a curve type classifier (not shown) and five individual surrogate NNs (e.g., surrogate models 641, 642, 643, 644, and 645) that predicts curve feature {X^{P}} (e.g., the estimated curves) given the design candidate {Y} (e.g., design candidates 631, 632, 633, 634, and 645). In embodiments, the inverse prediction module 620 consists of five individual generative neural networks (e.g., generative model 621, 622, 623, 624 and 625) that predicts the design candidate {Y} (e.g., design candidates 631, 632, 633, 634, and 645, respectively) based on the target curve feature {X^{T}} (e.g., features 610). In embodiments, the inverse prediction module 620 takes the target stress-strain curve features 610 as the input, predicts five design candidates (deign candidates 631, 632, 633, 634, 635), which are then passed to the forward validation module 640 to evaluate the mechanical responses and select the optimal design 660. While five generative models, design candidates, surrogate models, estimated curves (for each surrogate model) and average curves are depicted by FIG. 6A, it will be appreciated the invention is not limited to embodiments where only 5 of these are used, and it will be appreciated that more (e.g., 10, 15, 20, etc.) or fewer (e.g., 1-4) of each may be used.

FIG. 6B illustrates generative-surrogate model linkage in accordance with embodiments of the present invention. Each generative neural network may be linked to its corresponding surrogate neural network, forming a pair of generative-surrogate models. For example, as shown in FIG. 6B, generative model 621 may be linked to surrogate model 641. In embodiments, the output of each respective generative model (generative model 621, generative model 622, generative model 623, generative model 624, generative model 625) may be used to train (training 671, training 672, training 673, training 674, training 675, respectively) each respective surrogate model (surrogate model 641, surrogate model 642, surrogate model 643, surrogate model 644, surrogate model 645, respectively), and vice versa. FIG. 6A-6D illustrates five pairs of generative-surrogate model in the ML pipeline, but fewer, or more, pairs may be included in accordance with embodiments of the present invention.

FIG. 6C depicts multiple design candidates obtained from the inverse prediction module for the target curve shown in FIG. 6A in accordance with embodiments of the present invention. In embodiments, each design candidate 631, 632, 633, 634, 635 may be described by a T_{cell} number, an angle φ; and a ratio of strut radius to length r₁/L₁.

FIG. 6D depicts examples of estimated curves from the fifth surrogate model in accordance with embodiments of the present invention. In embodiments, the predicted curves 690 of design candidate 635 may be averaged (as shown by predicted curve avg 680) and compared with the target curve 610 in terms of the normalized root-mean-square error (NRMSE). In embodiments, after repeating this process for all models (e.g., 621, 622, 623, 624, 625)/all design candidates (E.g., design candidates 631, 632, 633, 634, 635), the optimal design 660 paired with a curve exhibiting the minimum NRMSE is selected. In embodiments, when the minimum NRMSE values are identical across multiple designs, the design candidate from an ML model with the highest prediction accuracy is chosen as the optimal design.

In embodiments, as a part of the ML pipeline, the curve type classifier in the forward validation module estimates the type of predicted stress-strain curves using the design parameters predicted from the inverse design module. This curve type along with such predicted design parameters are fed into each NN model of the forward module for the prediction of stress-strain curve features {X^{P}}. Thereby, as the optimal design are chosen via a direct comparison of curve features, the approach ensures the uniqueness of the solution and hence bypasses the potential one-to-many mapping issue that can occur in the typical inverse design approach.

### Curve Design Space

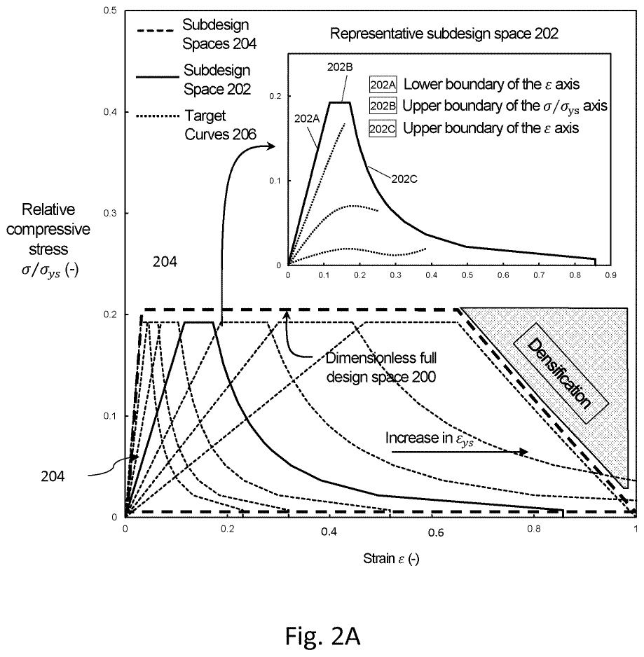

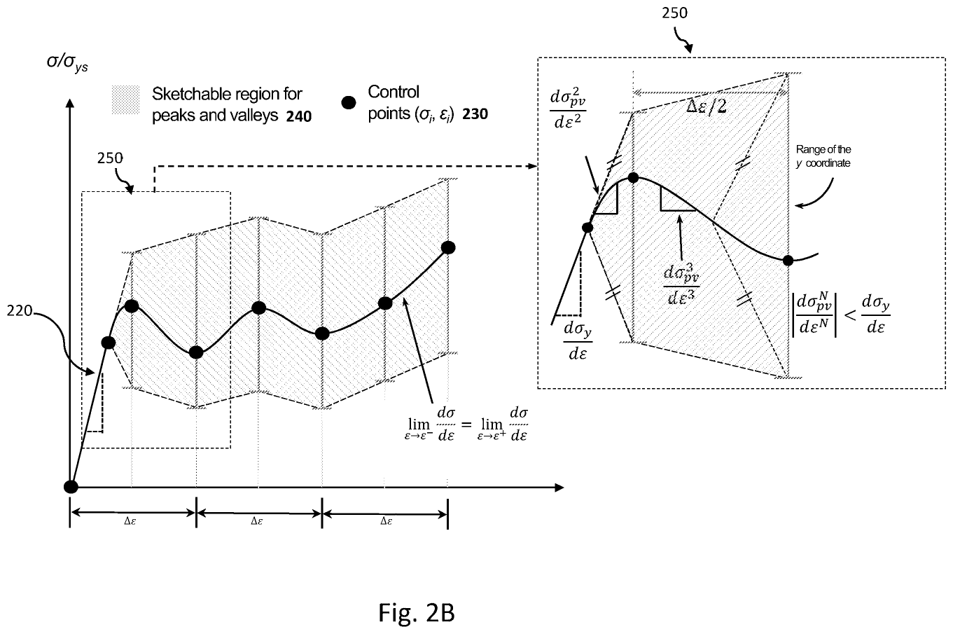

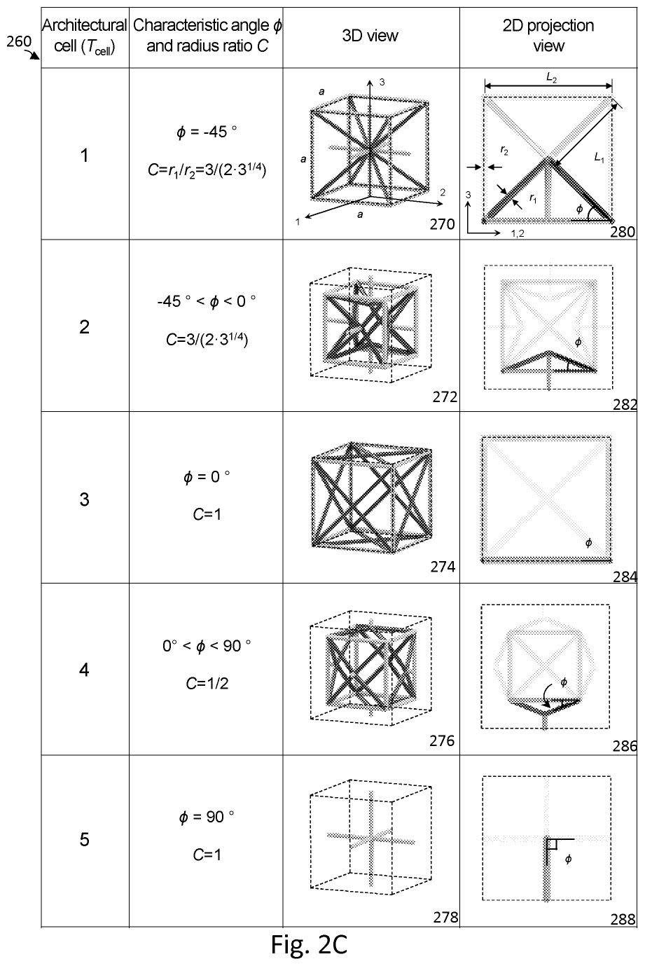

FIG. 2A illustrates a full stress-strain curve design space 200 composed of a series of subdesign spaces (e.g., subdesign spaces 204 and subdesign space 202) in a dimensionless plot in accordance with embodiments of the present invention. In FIG. 2, the x-axis specifies the strain and the y-axis specifies the relative compressive strength σ/σys (σys denotes the yield strength of the base material). Each subdesign space of the illustrated design space 200 is associated with a unique base material described by its elastic limit εys and constructed with three boundaries (e.g., 202A, 202B, and 202C of subdesign space 202 in inset), with a representative case enclosed by bold line 202 while others bounded by lighter lines depicted. Target curves (e.g., target curves 206) may be generated in a given subdesign space (e.g., subdesign space 202).

FIG. 2B illustrates example stress-strain curves in accordance with embodiments of the present invention. By way of illustration, FIG. 2B, provides an example of design rules for plotting target stress-strain curves. In embodiments, a target curve 220, described by control points 230 and their derivatives, starts with a straight line, followed by peaks and valleys. In embodiments, the target curve is within a sketchable region for peaks and valleys 240. Inset 250 provides a close up of a subset of control points 230 and their derivatives.

FIG. 2C provides examples of architectural cells with cubic symmetry in accordance with exemplary embodiments of the present invention. Table 260 of FIG. 2C includes 3D views 270, 272, 274, 276, 278 and 2D Projection views 280, 282, 284, 286, and 288 for given T_{cell}, characteristic angle, and radius ratio values. As shown table 260 of FIG. 2C, a variation in the characteristic angle (φ) from −45 to 90 degrees results in an architectural transformation from a compound truss comprising simple and body-centered cubic trusses (shown in 3D view 270 and 2D projection view 280) (T_{cell}=1) at φ=−45°, to an auxetic truss (shown in 3D view 272 and 2D projection view 282) (T_{cell}=2) at −45°<φ<0°, to a reinforced face-centered truss (shown in 3D view 274 and 2D projection view 284) (T_{cell}=3) at φ=0°, to a simple cubic truss combined with convex square pyramids truss (shown in 3D view 276 and 2D projection view 286) (T_{cell}=4) at 0°<φ<90°, and to a simple cubic truss (shown in 3D view 278 and 2D projection view 288) (T_{cell}=5) at φ=90°. In embodiments, each cell occupies an identical representative (black-dotted) volume and comprises two types of struts: inclined (angled struts, shaded light gray) and support struts (horizontal and vertical struts, shaded darkly) struts. These struts are related via a constant C, defined as the ratio of the radius of the inclined strut to the radius of the support strut (i.e., C=r1/r2).

In preferred embodiments of the present invention, the design region of the generative ML approach is formulated as a dimensionless design space (e.g., design space 200) enclosing the arbitrary mechanical behavior of cellular materials under both monotonic and cyclic uniaxial compression, where the x-axis specifies the strain ε and the y-axis specifies the relative compressive strength normalized to the yield strength of a given polymeric base material σ/σys (the full curve design space is highlighted by a black dashed region 200 in FIG. 2A). In embodiments, this dimensionless design space may comprise a series of subdesign spaces (e.g., subdesign spaces 204 and subdesign space 202) classified by the elastic limit (εys or σys/Es) of each available polymeric base material (depicted as dotted lines within the design space). This representation allows for the inclusion and visualization of most stress-strain curve shapes (e.g., target curves 206) for a given choice of polymeric base materials. In embodiments, in a dimensionless plot where the x-axis specifies the strain, and the y-axis specifies the relative compressive strength σ/σ_{ys} (σ_{ys} denotes the yield strength of the base material), each subdesign space, as illustrated in the inset of FIG. 2A, is constructed with three boundaries: (1) A lower boundary for the strain axis or x-axis (202A): described by the ratio of the maximum attainable strength to the highest attainable stiffness; An upper boundary for the relative compressive strength axis or y-axis (202B): represented by the maximum attainable strength; An upper boundary for the strain axis or x-axis (202C): characterized by failure strains and the corresponding maximum strengths. In embodiments, envelopes of the subdesign space are specified by the theoretical upper bounds of the elastic stiffness [27] and the yield strength [28] of isotropic cellular materials (represented as 202A and 202B, respectively, in the context of subdesign space 202 of FIG. 2A) and an approximated failure bound (represented as 202C in the context of subdesign space 202 of FIG. 2A), assuming that available polymeric base materials are isotropic and their post-yield behavior are negligible.

### Derivation of Stress-Strain Curve Design Space

In embodiments, the lower boundary for the strain axis (202A) can be determined by the maximum achievable stiffness and yield strength of an isotropic cellular material. These mechanical properties scale with the relative densities (ρ̅) of the cellular materials [43]. The maximum designable density (ρ̅ₘₐₓ) may be estimated as

$${\overline{ρ}}_{m ax} ∼ \sqrt{\frac{23}{12}} \frac{{σ}_{target}}{max ( {σ}_{y s} )}$$

where σ_{target} IS defined as the maximum strength of the target stress-strain curve and max(σ_{ys}) denotes the minimum yield strength of an available base materials. In embodiments, based on the maximum relative density, the maximum achievable stiffness and yield strength is obtained using the Hasin-Shtrikman (“HSU”) and Sequet (“S”) [28] bounds as Equation 1:

$$\frac{{E}_{HSU}}{{E}_{S}} = \frac{2 {\overline{ρ}}_{ma x} ( 5 v - 7 )}{13 {\overline{ρ}}_{m ax} + 12 v - 2 {\overline{ρ}}_{m ax} - 15 {\overline{ρ}}_{m ax} {v}^{2} + 15 {v}^{2} - 27 )} \qquad ( Equation 1 )$$

### and Equation 2:

$$\frac{{σ}_{y , SU}}{{σ}_{y s}} = {( \frac{12}{13} - \frac{11}{12} {\overline{ρ}}_{m ax} )}^{- 1 / 2} \qquad ( Equation 2 )$$

where the subscript s denotes the material properties of the base material. The lower boundary for the strain axis is marked as (202A) in the inset of FIG. 2A.

In embodiments, the upper boundary for the relative compressive strength axis (202B) is approximated as the theoretical upper bound of the yield strength (Eq. 2) with ρ̅ₘₐₓ. This treatment describes that failure occurs when local maximum stress within the lattice attains the yield strength of the solid constituent material.

In embodiments, the upper boundary for the strain axis (202C) is characterized by the maximum failure strain (ε_{ƒ}) and the corresponding maximum strength

$$( \frac{{σ}_{y , SU}}{{σ}_{ys}} )$$

evaluated at designable relative densities ranging from 0 to ρ̅ₘₐₓ. The estimated failure strain may be represented according to Equation 3:

$${ε}_{f} = ( \frac{{σ}_{y s}}{{E}_{s}} ) \frac{1}{{ρ}^{- 1 / 2}} \qquad ( Equation 3 )$$

and the corresponding maximum strength may be represented by Equation 2. This function reflects a general deformation trend of architected materials-low-density materials fail at a higher strain than high-density materials while the maximum strength at failure decreases gradually.

### Stress-Strain Input Curve

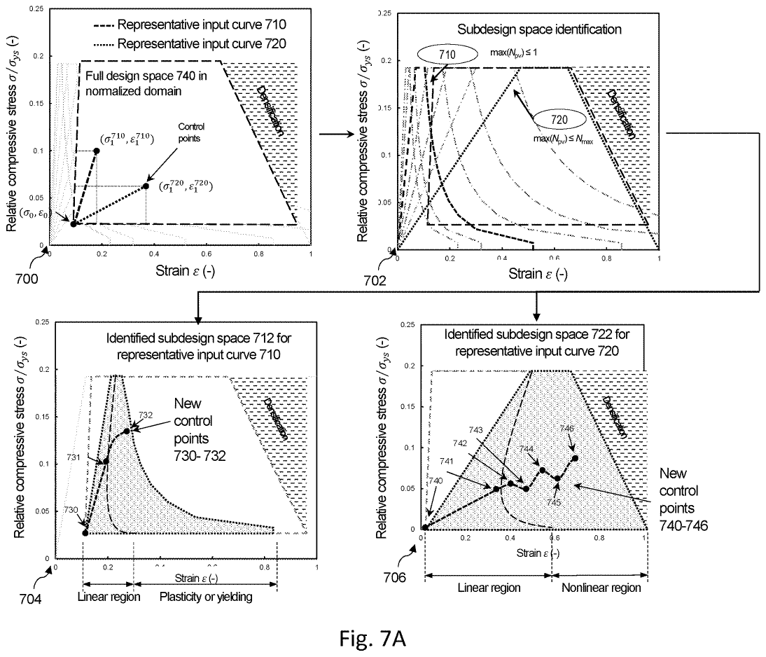

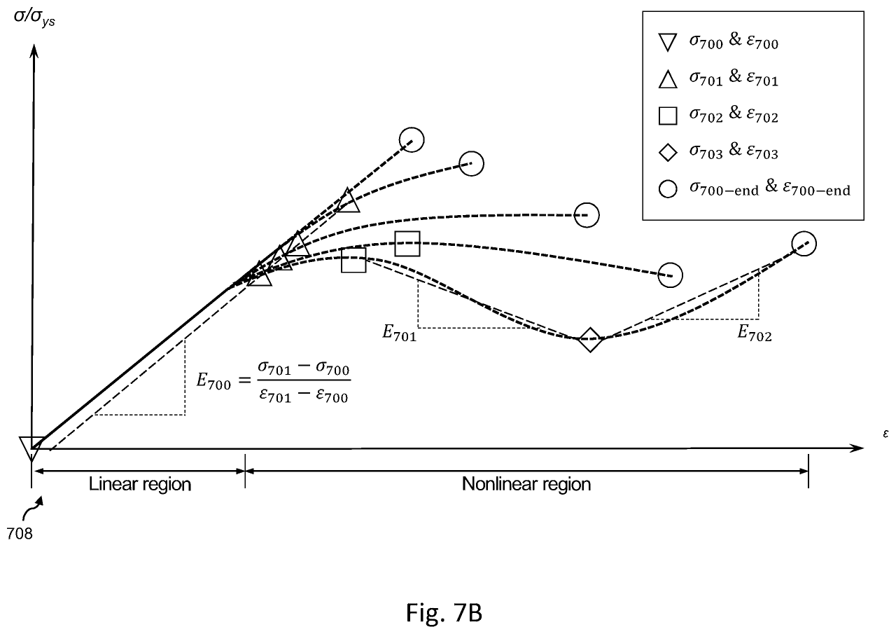

Referring now to FIG. 2B, within the full design space formulated above, the generative ML approach of the present invention may take an arbitrary compressive stress-strain curve 220, either monotonic or cyclic, as the input. In embodiments, this target curve 220 may be constructed via sequentially connecting control points 230 assigned by the user (e.g., using a user input device, not shown), starting from the origin to linear elastic limit, followed by local maxima and/or minima, and terminating at the end point (the design rules are shown in FIG. 2B; see FIG. 7A-7B for an example of the stress-strain curve input process). The first segment of the target curve is a straight line described by two control points at the origin and the linear elastic limit (i.e., (ε0, σ0) and (ε1, σ1)), representing linear-elastic behavior, and the slope of this straight segment (E0) denotes the elastic modulus of the material under compression. After the linear elastic segment, the subsequent segments between successive control points (εi, σi) denote the nonlinear behavior of the material, where the maximum number of control point index i is dictated by the initial slope (E0) and given print parameters.

In embodiments, control points 230 of the stress-strain curve 220, along with load type (Tload) (either monotonic or cyclic), strain energy (ΔU) (area enclosed by the curve), and slope (Ei) between two adjacent control points, forms a total of 46 curve features {X} (e.g., curve features 110, 610) which may be used as the input to the ML pipeline (e.g., as inputs to the inverse prediction modules 120, 620).

FIGS. 7A and 7B depict plottable stress-strain curve paths in accordance with embodiments of the present invention. Plot 700 depicts linear segments of two representative target curves 710 and 720 in the full design space 704 from user input. Plot 702 id a contour map showing the achievable number of peaks and valleys of the curves based on the subdesign space 740. Plots 704 and 706 depict nonlinear segments of the representative target curves (curves 710 and 720, respectively) within the corresponding subdesign spaces (subdesign spaces 712 and 722 respectively). In embodiments, the nonlinear segments are based on new control points (e.g., new control points 730, 731 and 732 for subdesign space 712 and new control points 740-746 for subdesign space 722) which completes a sketch of the curves. FIG. 7B depicts exemplary compressive stress-strain curve paths described by several curve features for a special case of max (Npv) equal to unity plotted in plot 708.

According to embodiments of the present invention, stress-strain curves are parameterized by curve features (Xi), where i ranges from 1 to 6×max(Npv)+10 and max (Npv) describes the maximum number of achievable peaks and valleys. These curve features may be specified by identifying control points (εj, σj) from the curve where j varies from 0 to 2×max(Npv)+2. The relationship between the curve features and control points are provided in Table 1:

TABLE 1

| Curve feature | | |
|---|---|---|
| {X} | Description | Method of determination |
| X₁ | Loading type (T [symbol] ) | 0 (i.e., monotonic response) |
| | | if σ ( [symbol] ) ≠ (ε_{end}) |
| | | 1 (i.e., cyclic response) |
| | | if σ (ε₀) = σ (ε_{end}) |
| X₂ | Stored energy per unit volume(U [symbol] ) | ${U}^{loading} = {\int }_{{ε}_{0}}^{{ε}_{end}} {σ}^{loading} d ε$ |
| X₃ | Released energy per unit volume (U [symbol] ) | ${U}^{unloading} = {\int }_{{ε}_{0}}^{{ε}_{end}} {σ}^{unloading} d ε$ |
| X₄ | Dissipated energy | ΔU = U^{loading} - U^{unloading} |
| | per unit volume (ΔU) | |
| X₅, X₇, . . . X₂₉ | Stress (σᵢ) | Note: 0.2% offset method |
| | | used for i = 1 |
| X₆, X₈, . . . X₃₀ | Strain (∈ [symbol] ) | |
| X₃₁ | End stress (σ_{end}) | End of the curve if T_{load} = 0 |
| X₃₂ | End strain (∈_{end}) | Maximum strain and the |
| | | corresponding stress if T_{load} = 1 |
| X₃₃ ~ X₄₀ | Stiffness (Eᵢ) | ${E}_{i} = \frac{{σ}_{i + 1} - {σ}_{i}}{{ε}_{i + 1} - {ε}_{1}}$ |
| | | where j = 1 . . . 2 × max (Nₚᵥ) + 2 |
| | | Note: elastic stiffness when i = 0 |

[symbol]

indicates data missing or illegible when filed

In embodiments, the stress-strain curve parameterization process may be implemented in Python with packages such as numpy [44], SciPy [45], and pandas [46] packages.

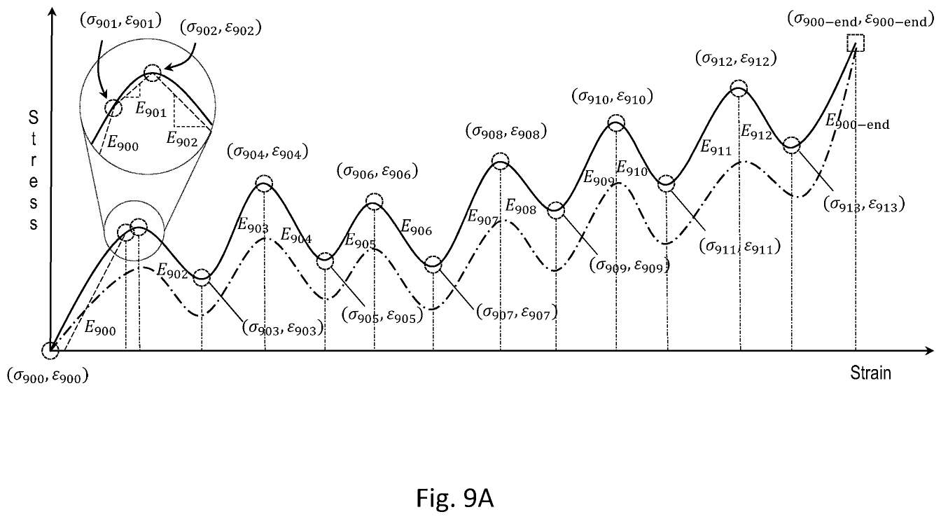

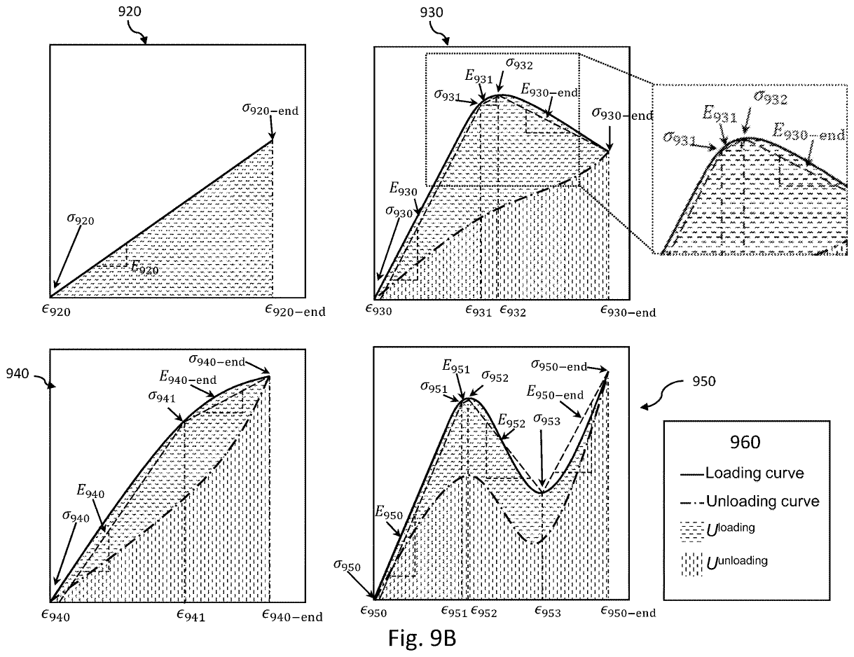

FIG. 9A depicts an example of stress-strain curve parameterized in terms of curve features in accordance with embodiments of the present invention. In FIG. 9A, the curve features are parameterized to fully describe their important mechanical properties, depicting an embodiment where max (Npv) 6, and omitting the variables describing the loading type and energy terms (i.e., Tload, Uloading, Uunloading, ΔU).

FIG. 9B depicts illustrative examples 920, 930, 940, 950, 960 of the curve parameterization for several curve paths in accordance with embodiments of the present invention.

In embodiments, in the case of the training curve, the first step of the parameterization process may include an identification of their control points (FIG. 9A). The identified control points were then assigned to the curve features according to the descriptions listed in Table 1. In detail, the identification process may begin with filtering noisy data presented in the curve to minimize any data fluctuations and inconsistency [47] by using the Savitzky-Golay definition [48]. Upon the completion of the filtering process, the beginning of the curve may be set to (ε₉₀₀, σ₉₀₀) and a load type (T_{load}) may be determined by recognizing whether the initial and terminating stress values of the curve were identical. A nonlinear segment at the beginning of the curve (also known as the toe-in region) may also be detected and temporarily deactivated to minimize inaccuracy in the following elastic modulus (E₉₀₀) measurement (the slope of the linear segment of the curve). The elastic modulus may be computed by using a linear least-squares regression [45] with the coefficient of determination set to 0.999. According to a typical 0.02% strain offset method, a straight line with a slope described by the computed E₉₀₀ was determined, from which an intersecting point of this line and the curve was set to (ε₉₀₁, σ₉₀₁), representing the termination of linearity. In embodiments, when this point is not detectable, the ending of the curve may be set to (ε_{900-end}, σ_{900-end}) which represents failure without appreciable yielding as illustrated in the upper left sub-figure in FIG. 9B. Subsequent stresses and strains after the linear segment—control points denoted by (ε90j, σ90j) where j=2 . . . 13—are identified by locating local maxima and minima of the curve. Finally, (ε_{900-end}, σ_{900-end}) are set by recognizing terminating stress and strain values of the curve. Once all control points are identified, they are assigned to the corresponding curve features (Xi where i=5 . . . 32) according to the control point-curve feature relationship provided in Table 1. According to embodiments of the present invention, the remaining curve features (Xi where i=1 . . . 4 and 33 . . . 46) may be recognized from the previously determined T_{load} and E₉₀₀ as well as additional variables such as strain energies and tangent moduli in the nonlinear segment of the curve.) As before, these variables were assigned to the corresponding curve features as listed in Table 1, and this completed the stress-strain curve parameterization in case of the training curve. Legend 960 provides information on the lines and shading of FIG. 9B.

In exemplary embodiments, in the case of the target curve, the aforementioned identification process of the control points may not be necessary as these points may be specified by the user. Hence, with the user-specified control points, the curve parameterization process may be completed by determining the additional variables discussed above and assigning them to the corresponding curve features, as listed in Table 1

### Architectural Cells for Training

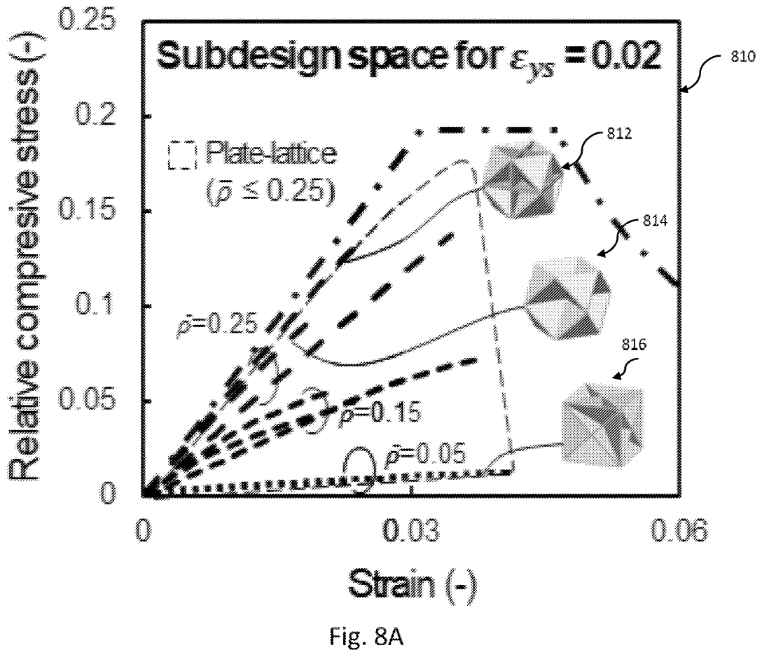

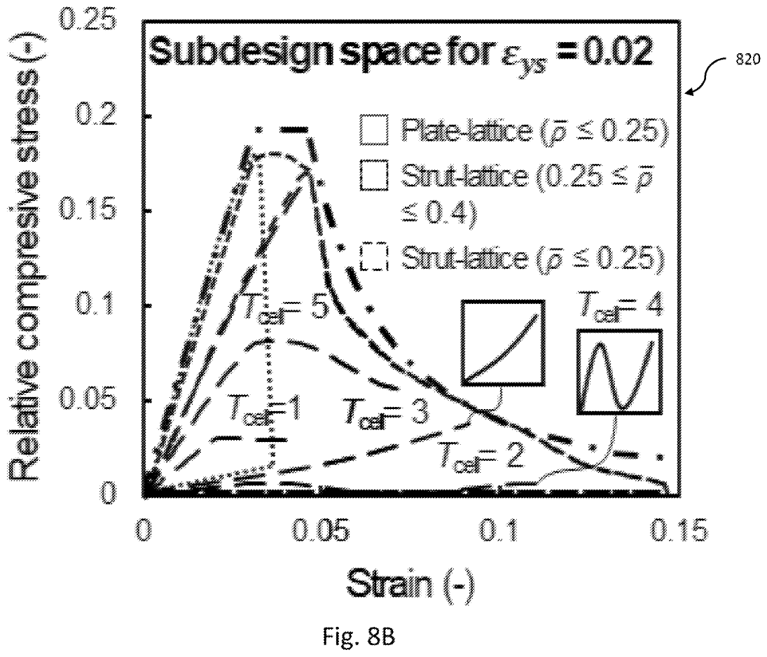

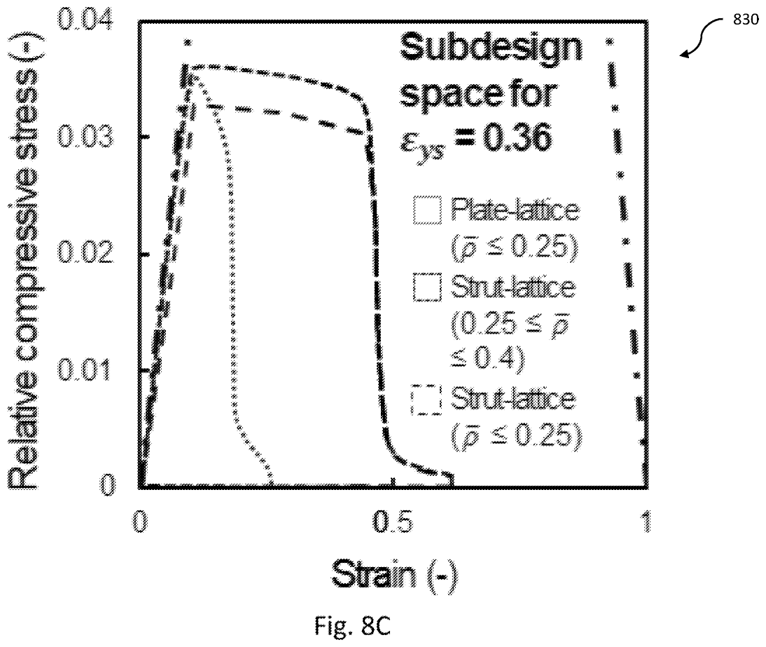

Referring back to FIG. 2C, according to an exemplary embodiment of the present invention, a family of cubic symmetric, strut-based architectural unit cells may be used to generate training datasets of the ML approach. In embodiments, the cells are represented by design parameters {Y} that describe a lattice architecture, namely, the cell type (Y1 or Tcell), the characteristic angle (Y2 or φ), and the radius-to-length ratio of the inclined strut (Y3 or r1/L1). In embodiments, the evolution of φ, together with r1/L1 tuning, not only changes the relationships among tensile and compressive load-bearing strut members, nodal connectivity, and strut slenderness ratio but also controls the deformation mechanism of the cells, thereby giving rise to distinct stress-strain curves (an exemplary mechanical performance assessment is provided in FIGS. 8A-8C).

FIGS. 8A-8C depict exemplary mechanical performance assessments of the architectural unit cells in accordance with embodiments of the present invention. FIG. 8A shows a graph 810 depicting sample FE simulations showing representative stress-strain curves of typical plate-lattices in a subdesign space for εys of 0.02 (relatively brittle base material). In graph 810, responses of SC-FCC, BCC, and FCC are labelled with their corresponding geometrical shape and by 812, 814 and 816, respectively. FIG. 8B shows a graph 820 which depicts exemplary results of FE simulations showing representative stress-strain curves of the strut-based architectural unit cells (Tcell of 1 through 5 of FIG. 2C) and their coverages in the same subdesign space as depicted in graph 810 for a comparison. FIG. 8C shows a graph 830 depicting exemplary results of FE simulations illustrating coverages of the strut-lattices and plate-lattices in another representative subdesign space for sys of 0.36 (a relatively flexible base material).

Due to the inherent cubic symmetry of the described architectural cells, their mechanical behaviors are invariant in three orthogonal directions. An advantage of embodiments of the present invention is that this characteristic enables an effective, direct tessellation across different architectures for the creation of compound lattices (i.e., a lattice made of different unit cells) offering enhanced stress-strain curve tunability. Hence, the developed unit cells allow the ML approach to capture diverse stress-strain curve paths while occupying nearly the full range of the design space.

### Training Dataset Generation

The developed architectural cells may be used to generate a training dataset containing design parameters {Y} and their corresponding stress-strain curve features {X} (i.e., {X}-{Y} pairs). In embodiments, the variables φ(or Y2) and r1/L1 (or Y3) may first be discretized into a number of intervals to create hundreds of basic architectural configurations. Each configuration may be tessellated in three principal directions to create a 3D lattice digital model with the overall dimension of 20×20×20 mm³ (two unit cells in each orthogonal direction). In embodiments, three samples may be fabricated for each digital model using digital light 3D printing with a brittle polymer. In embodiments, stress-strain curves of the as-printed lattice samples may be measured by monotonic compression and cyclic compression experiments. The measured stress-strain curve of each architectural configuration may then be parameterized into 46 curve feature variables {Xi, i=1 . . . 46} and paired with the corresponding design parameters {Yi}, leading to, for example, 1212 {X}-{Y} pairs in a pristine dataset. As these pairs provide links between the curve features of the experimentally measured curves and the corresponding lattice designs, the training dataset, an advantage of this training method is that it accounts for process variability (e.g., uncertainty and imperfections) stemming from fabrication and experimental measurements.

In embodiments, as the forward module performs “many-to-one” mapping, data augmentation may be carried out on these pairs to account for prediction fluctuation and to achieve satisfactory prediction accuracy (e.g., >90% accuracy). Augmentation may result in a greater number of pairs in an augmented dataset. For example, augmentation of 1212 {X}-{Y} pristine pairs may result in in 9360 {X}-{Y} pairs in the augmented dataset. In embodiments, data augmentation may include generating new datasets with normalized values based on the pristine dataset. In embodiments, the curve type (T_{curve}) may be added into {X}, and may represent linear, plastic yielding, buckling and multiple peak-and-valley response curves. In embodiments, one-hot coding may be used (e.g., such that [1,0,0,0] may correspond to a linear curve type) to encode the curve type.

### Machine Learning Model Training

In embodiments, for training of the generative ML pipeline, the forward module with the augmented dataset may be trained first. In embodiments, the forward validation module predicts the curve type (via a curve type classifier) and curve features {X^{P}} (via a curve feature regressor) of a given lattice design. In embodiments, the forward validation module includes more than one model (e.g., it may include five models). In embodiments, the models comprise one or more layers of hidden neurons, with larger numbers of neurons increasing the accuracy of the design. In embodiments, the forward module acts as a surrogate model that replaces the conventional simulations used to evaluate the responses of a design. In embodiments, the models are trained using the augmented dataset. An exemplary training set consists of 70% the augmented dataset. In embodiments, a stochastic gradient descent optimizer is be used to minimize the error between predicted and target curve types.

An advantage of the present invention is that simulation times may be reduced. For example, as compared to conventional simulation typically requiring hours to compute the mechanical behavior of a 3D lattice design, the forward module may take seconds to evaluate the mechanical behavior, which can greatly shorten the time span of the entire design process.

In embodiments, once the forward module is trained, this module may be kept frozen (i.e., the weight and bias parameters of all surrogate models are fixed) and then used to train the inverse prediction module with the pristine training dataset. In embodiments, in the training process of the inverse module, the cost function ƒc=(X^{P}−X^{T})², which evaluates the difference between the predicted stress-strain curve features {X^{P}} and the target curve features {X^{T}} for a given architecture {Y}, may be used to optimize the hyperparameters of all the NN models. An advantage of doing so is that it may limit instability during training and prevent {Y} from becoming a meaningless latent space variable.

### Inverse Design Based on Various Stress-Strain Curves

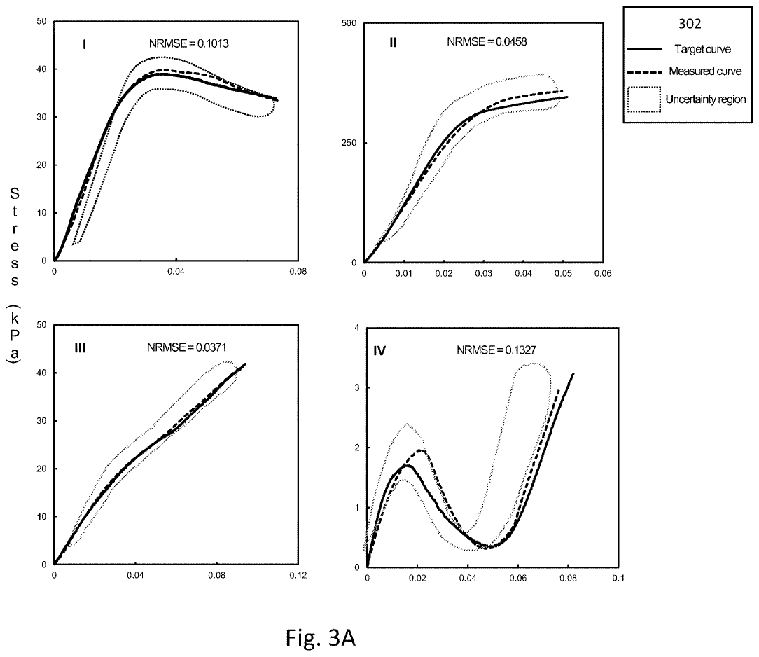

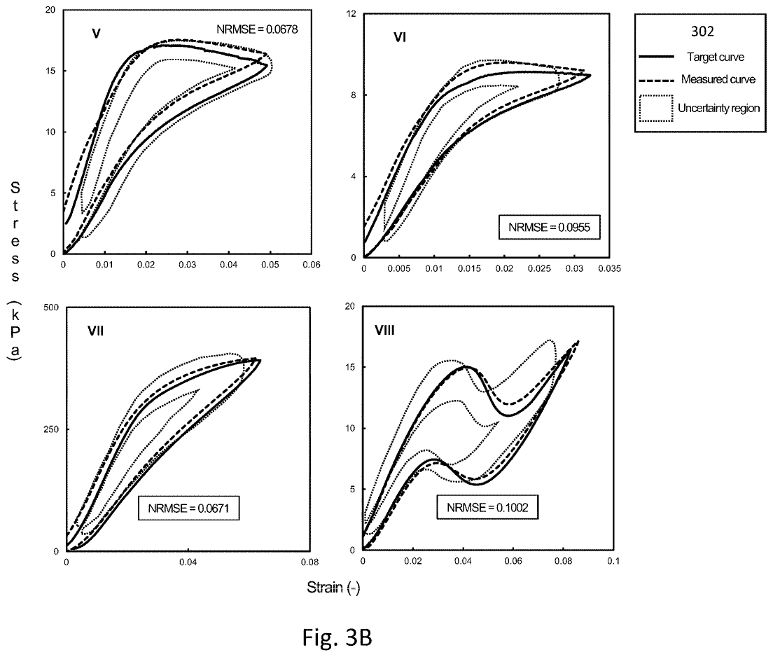

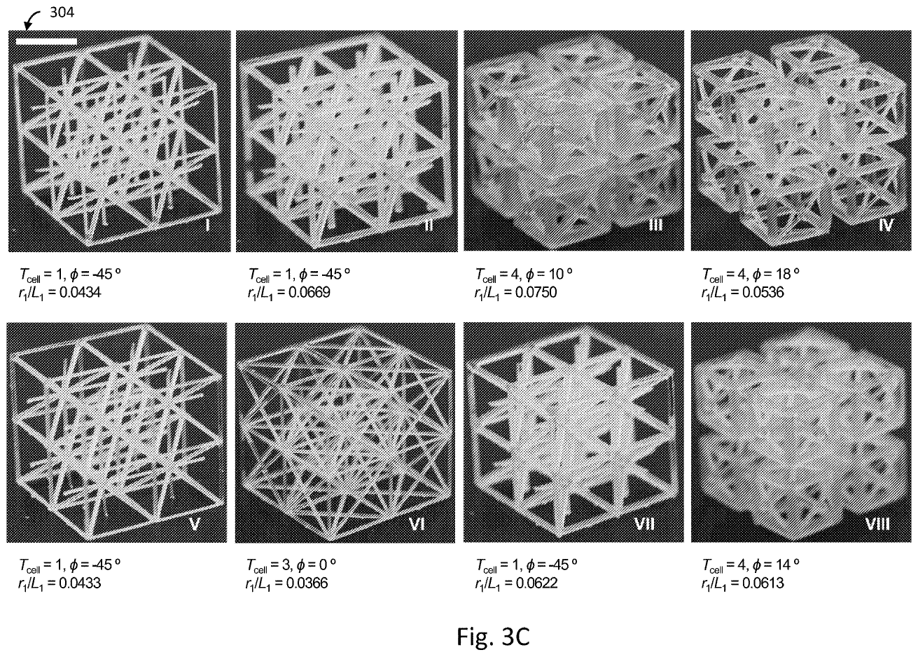

FIG. 3A depicts target and measured curves in accordance with embodiments of the present invention based on monotonic compression loadings. FIG. 3B depicts target and measured curves in accordance with embodiments of the present invention based on cyclic compression loadings. FIGS. 3A and 3B are based on representative target stress-strain curves representing various compressive mechanical responses, spanning linear elastic behavior followed by either a negative, nearly zero, or positive tangent modulus to a multislope tangent modulus, in response to monotonic (I~IV, FIG. 3A) and cyclic (V~VIII, FIG. 3B) compression loadings. As shown by legend 302, the solid curves denotes the target curves (input), whereas the dashed curves represent selected measured curves (output) of the printed samples. The uncertainty region, the area within the dotted lines, covers the distribution of ten experimentally measured curves, illustrating process variability. The normalized root-mean-square error (NRMSE) quantifies the curve similarity between the target and all the measured curves, with 0 corresponding to an identical curve pair, and 1 corresponding to a completely dissimilar curve pair.

FIG. 3C depicts photographs of the printed samples inversely designed by the machine learning predicted design parameters for the target curves in accordance with the present invention. The scale bar 304 (white) is 10 mm. The photographs (I-VIII) correspond to the graphs of FIGS. 3A and 3B.

In embodiments, the ML approach is used to create the inverse design of representative stress-strain curve paths of a cellular solid subjected to monotonic and cyclic compression. As illustrated in FIGS. 3A and 3B, in embodiments, target curve paths include (i) a linear-elastic section followed by an negative stiffness section, depicting buckling (cases I and V); (ii) linear-elastic sections followed by positive and nearly zero stiffness sections, illustrating strain hardening and plateau regions, respectively (cases II and VI); (iii) a linear-elastic section followed by immediate fracture, characterizing brittle behavior (cases III and VII); and (iv) a linear-elastic section followed by controlled post-buckling, showing a snap-through response (cases IV and VII). In embodiments, these target curve paths (dark, solid curves) may be significantly different from any curves in the training dataset, suggesting that the ML approach of embodiments of the present invention does not rely upon explicit prior knowledge of these curves.

As an example, the curve paths were fed into the ML pipeline to obtain the optimal design parameters, from which ten samples for each curve path were additively manufactured via the same 3D printing apparatus used for the training database generation. Exemplary representative printed samples and the predicted optimal design parameters are shown in FIG. 3B. Exemplary results of the inverse design of the representative stress-train curve paths are shown in FIGS. 3A and 3B. FIGS. 3A and 3B depicts the best matching curve (black dotted curve) from ten measured stress-strain curves for each case as compared against the corresponding target curve (gray solid curves), and the uncertainty zone, describing the distribution of the test curves from ten printed samples, represents manufacturing variability. As depicted, there is a high degree of similarity between the target curve and best matching curve for all cases (highlighted by the computed normalized root-mean-square error close to zero, e.g., less than 0.15), showcasing that the presently described method automatically takes into account various manufacturing defects in stereolithography, which may vary sample by sample and even strut by strut. This scope is very challenging or impractical to capture with other approaches, such as topology optimization, and represents an advantage of embodiments of the present invention over conventional approaches [24].

The ML approach of embodiments of the present invention is also applicable to other AM platforms exhibiting larger process variabilities with minimal decreases in reliability. In exemplary embodiments, when the process variability (n), defined as the ratio of the deviation to averaged value of mechanical properties of printed samples, increases by a factor of ~2.6, which makes the printing process comparable to that of the selective laser sintering process [29-32], the overall prediction accuracy of the present ML approach is reduced by only ~7%, resulting in an acceptable uncertainty region for the inverse design. While accuracies for recreating materials in response to larger processing errors could be compensated by incorporating larger training data sets, augmenting data and utilizing noise filtering and smoothing to eliminate irrelevant information, other manufacturing defects, such as anisotropy, porosity, shrinkage and micro-structural evolution that are unique to metal additive manufacturing is not accounted for in the present method.

### Tailorability of Stress-Strain Curves

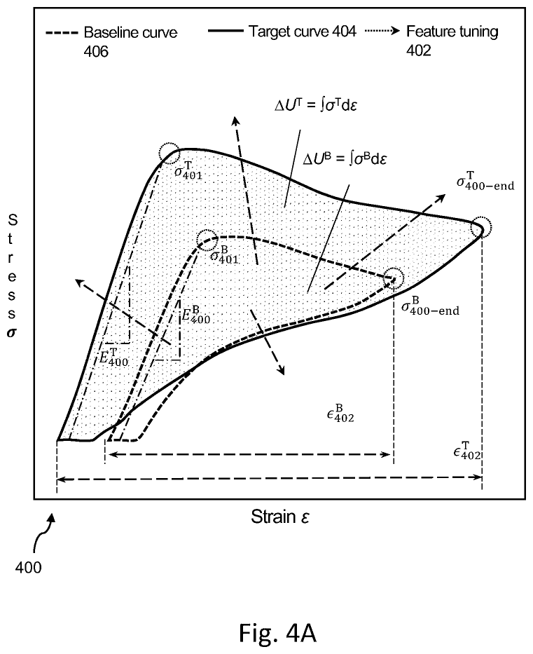

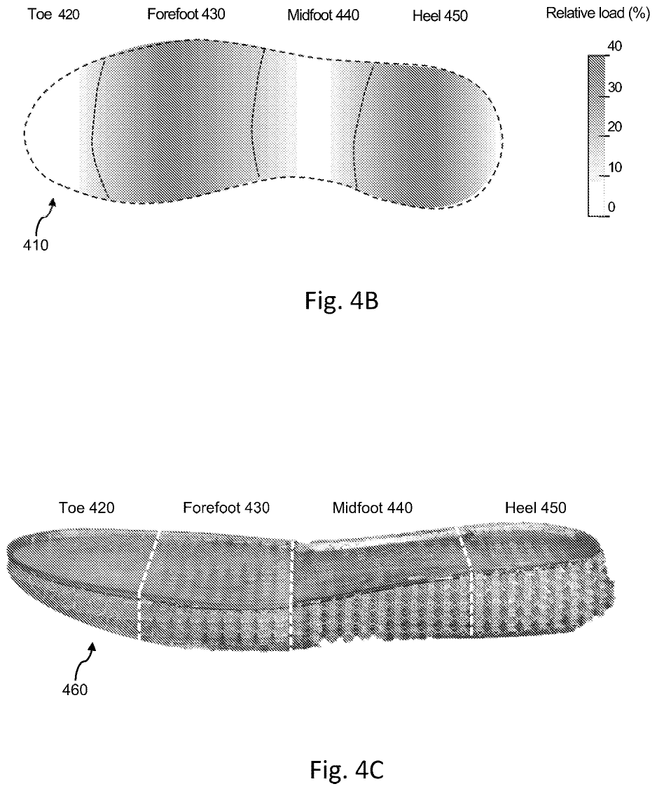

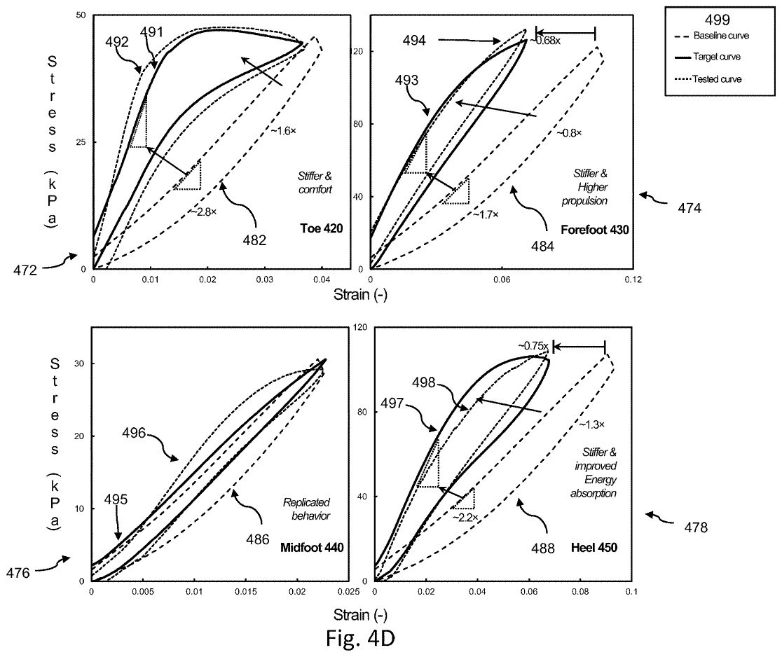

FIGS. 4A-4D relate to the design process, printing and testing of an architected midsole design in accordance with embodiments of the present invention.

FIG. 4A depicts the tailoring process to improve the energy absorption behavior for the architected midsole design in accordance with exemplary embodiments of the present invention.

FIG. 4B illustrates relative load distribution of the midsole during running [32]. FIG. 4C illustrates a photograph of a midsole sample designed and printed in accordance with exemplary embodiments of the present invention. In FIG. 4C, each section was designed to exhibit disparate target behaviors. The scale bar is 10 mm.

FIG. 4D illustrates a series of target and measured stress-strain curves of an architected shoe midsole sample designed and printed in accordance with the present invention.

In embodiments, architected materials that meet multiple target properties may be inversely designed via graphically tailoring curve features of a target stress-strain curve, for example by adjusting stiffness, peak stress, compressibility, and/or nonlinear response (see, e.g., tailoring image 400 of FIG. 4A). In embodiments, a user may perform these adjustments manually (e.g., using feature tuning 402, to give an example) or they may be performed by a computing device.

In an illustrative embodiment, the present invention was used to design an architected shoe midsole by graphically tailoring stress-strain curves measured from a commercial midsole (i.e., baseline curves 406 of FIG. 4A, and baseline curves 482, 484, 846, 488 of FIG. 4D) for enhanced running performance. In this example, a midsole 410 was partitioned into four sections (toe 420, forefoot 430, midfoot 440, and heel 450) based upon different levels of loads observed during heel-toe running [33] (see FIG. 4B), and the target stress-strain curve for each section was created by tailoring a baseline curve for the purpose of maximizing running propulsion and cushioning (FIG. 4A, 4D). The baseline response of the commercial midsole for each section (baseline curves 482, 484, 486, 488) was tailored to achieve a specific design target aiming at an improved running performance (see, e.g., target curve 404 of FIG. 4A, and target curves 491, 493, 495 and 497). Legend 499 of FIG. 4D shows that baseline curves from a commercial midsole are dashed, target curves are solid, and tested curves are dotted.

In the example, the tailored midsole 410 consists of a stiff but comfortable toe section 420, firmer and higher propulsion forefoot section 430, and stiffer yet energy dissipative heel section 450. In embodiments and in this example, the target curves are scaled according to the scaling relationship of the base material (TMPTA) between strain rate and its mechanical properties so that dynamic responses in running scenario can be inversely designed using quasistatic training data. The tailored/target curves were then fed into the machine learning modules in accordance with embodiments of the present invention, and the predicted designs were verified via experiments to determine stress and strain (see tested curves 492, 494, 496 and 498 of FIG. 4D). A fabricated midsole sample 460 with optimal design parameters for each section is shown in FIG. 4C. As shown in FIG. 4D by charts 472, 473, 474, and 475, corresponding to measurements of the toe 420, forefoot 430, midfoot 440, and heel 450, the experimentally tested curves 492, 493, 494, and 496 displayed excellent agreement (>90% average prediction accuracy) between target curves 491, 493, 495, and 497, respectively, of each tailored section, indicating that the ML pipeline is capable of creating materials satisfying multiple tailored mechanical responses under different loading conditions.

### Enhanced Tailorability Via Compound Lattices

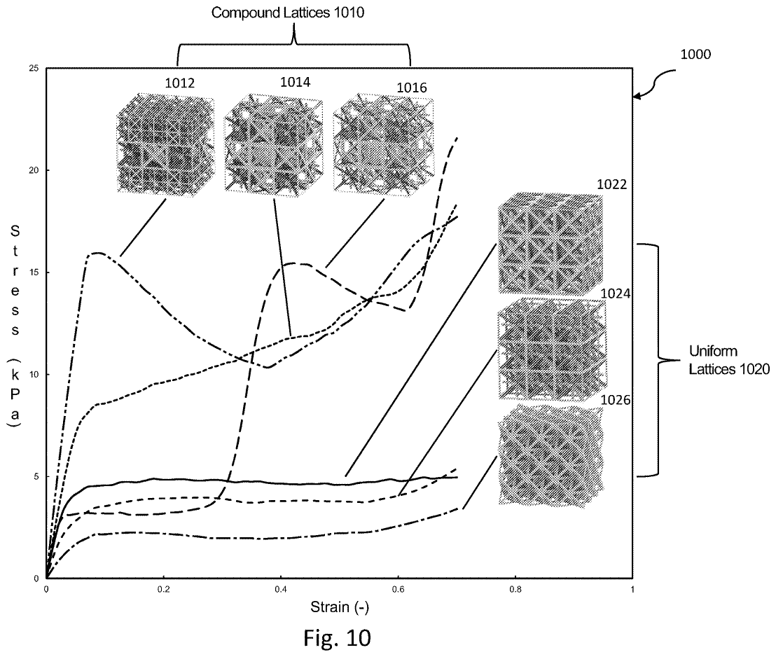

FIG. 10 depicts illustrative stress-strain capability of compound latices in accordance with embodiments of the present invention. FIG. 10 includes an illustrative comparison 1000 of stress-strain curves corresponding to compound lattices 1010 (e.g., compound lattices 1012, 1014, and 1016) created with superposed design gradients and uniform lattices 1020 (e.g., uniform lattices 1022, 1024, 1026). This illustrates the tailorability of aspects of the present invention.

In embodiments, the inverse design of architected materials include advanced curve features that do not exist in natural materials, such as variable tangent modulus, controllable softening/hardening effects, and multiple peaks and valleys. These curve features may offer improved crushing behavior and energy absorption performance and in embodiments may be realized by inversely designing compound lattices (non-uniform lattice comprised of design parameters varying by location, such as compound lattices 1010) with tailorable mechanical behaviors that go beyond mechanical responses from uniform lattices (lattice materials comprised of identical unit cells throughout the lattice, such as uniform lattice 1020). In embodiments, a training dataset is used for training one or more machine learning modules which includes compound lattices (e.g., compound lattice 1010, to give an example) made of a flexible polymeric base material via FE simulations.

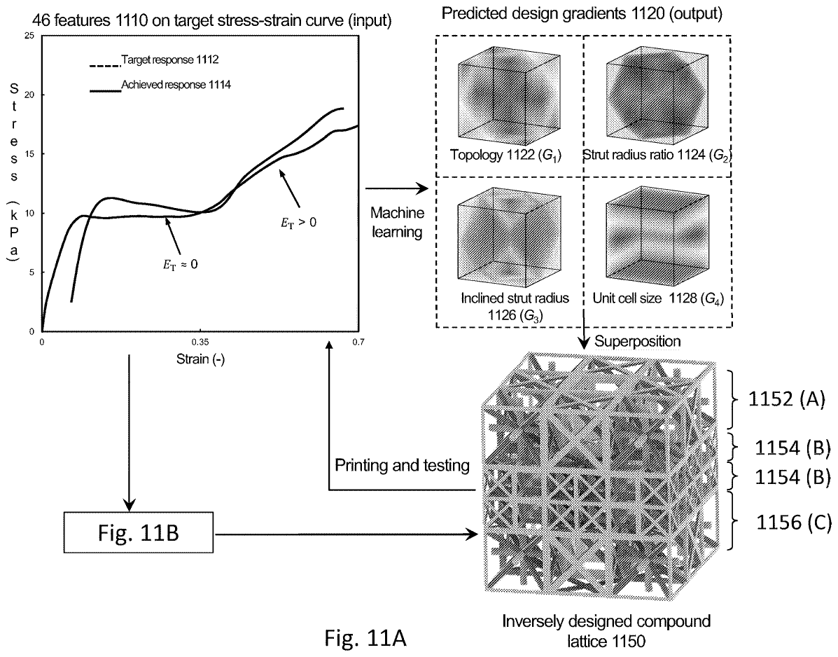

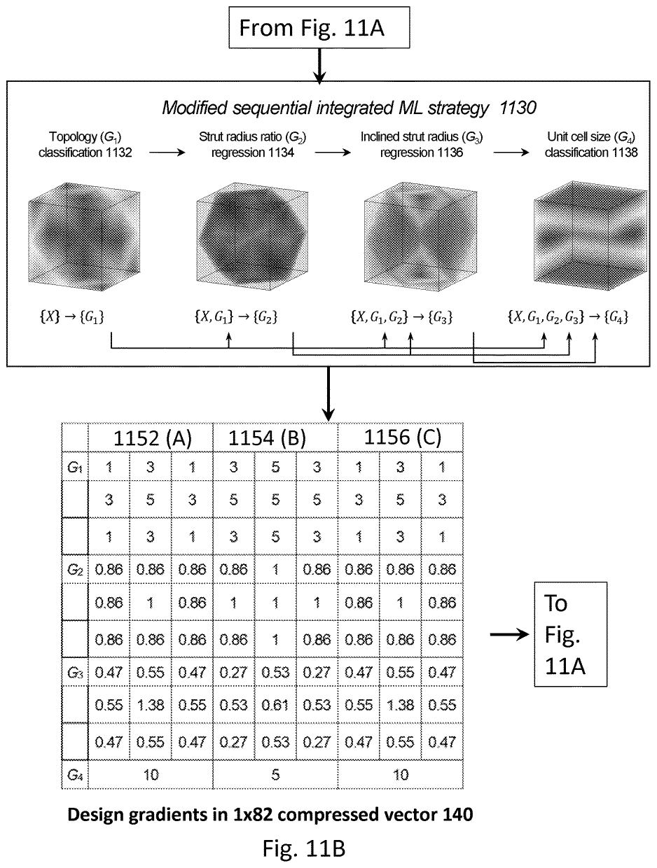

In embodiments, instead of, or in addition to, being represented by uniform design parameters, compound lattices are described by variation of design parameters (topology or design gradients) within a confined lattice volume, such as the unit cell type, strut aspect ratio, inclined strut diameter, and cell size gradients. In embodiments, the design gradients may be characterized by different spatial directional vectors (e.g., linear, concentrical, diagonal, and cylindrical, to name a few). In embodiments, the pristine and augmented training set include data representing compound lattices and stress-strain curves generated thereon. In embodiments, to adopt the structure of the gradient labels, a sequential integrated strategy for the inverse design process is deployed, as discussed further with respect to FIG. 11.

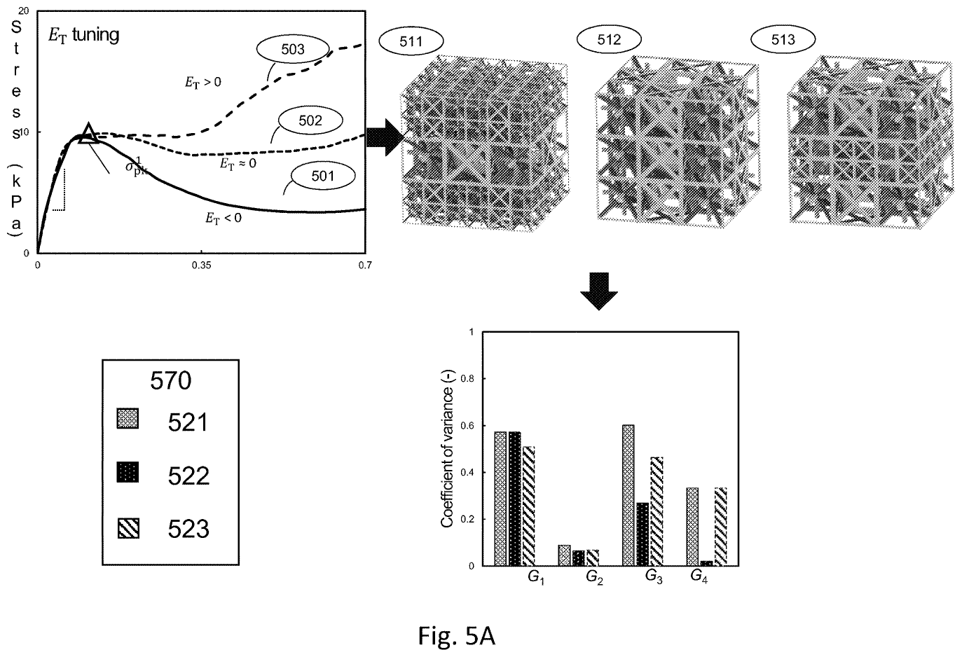

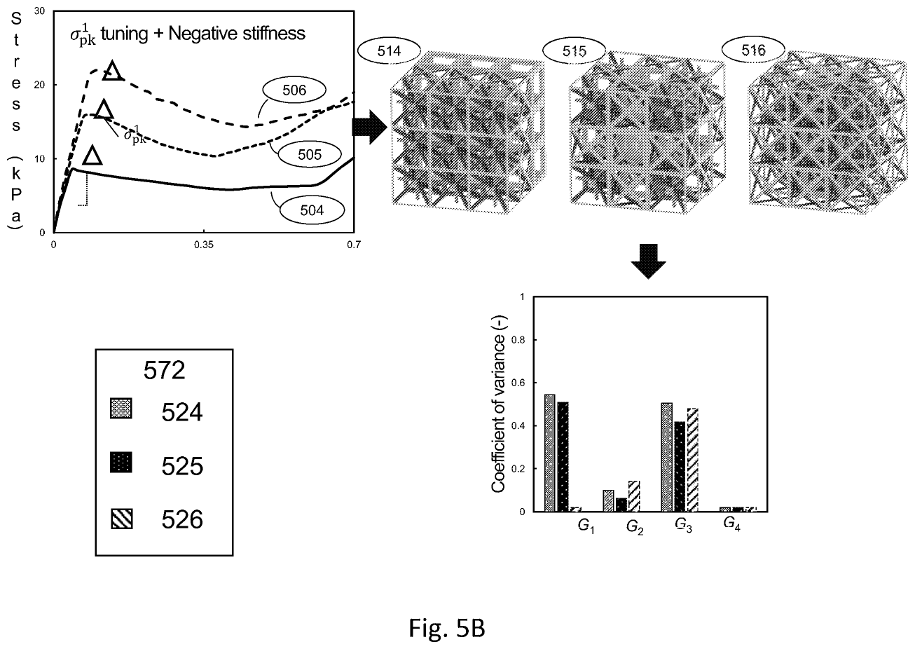

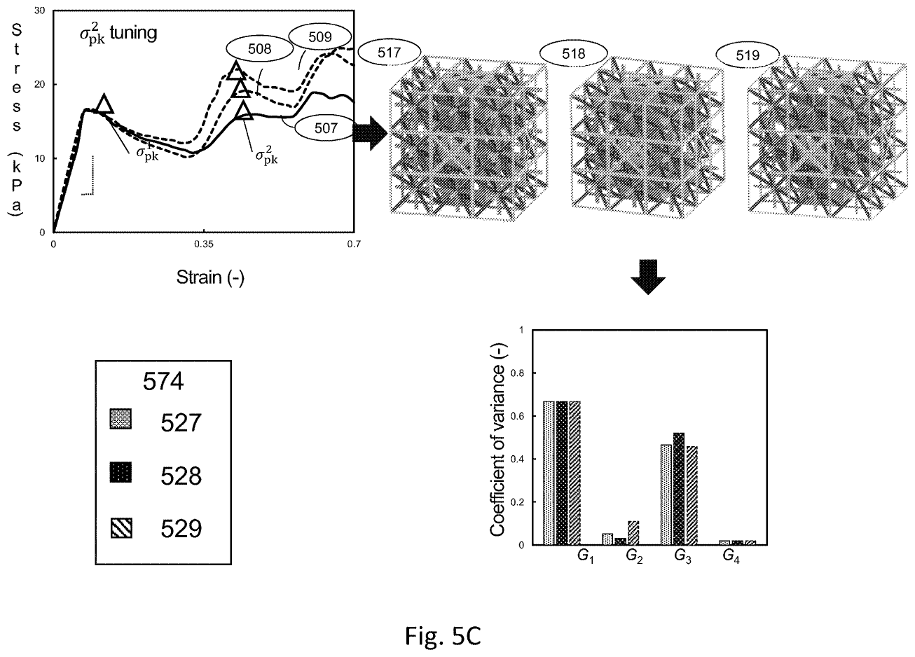

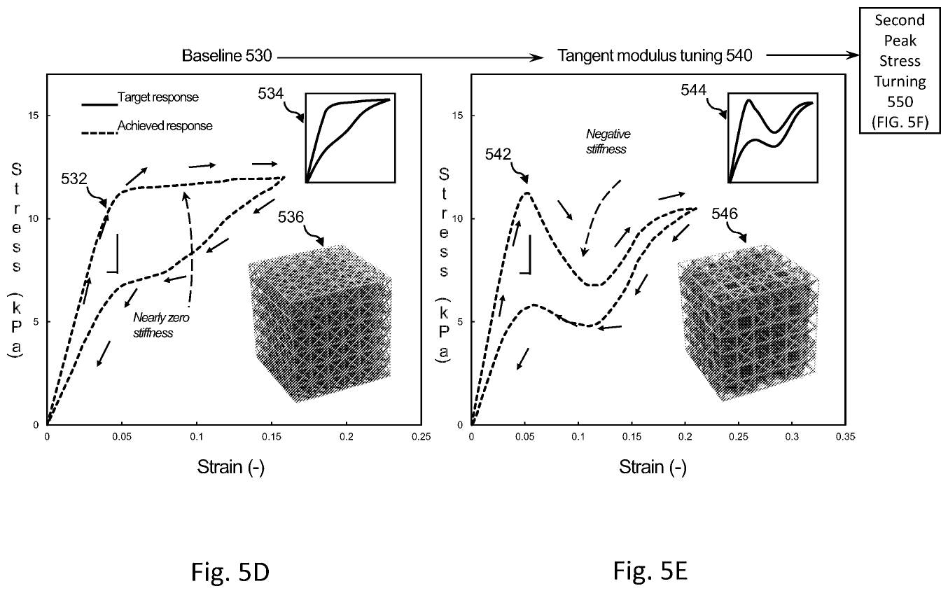

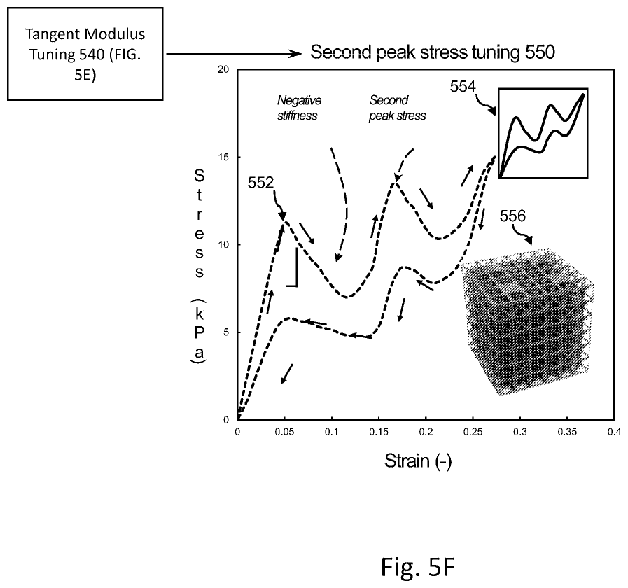

FIGS. 5A-5F illustrates enhanced stress-strain curve tailorability through compound lattice creations using superimposed design gradients in accordance with embodiments of the present invention.

FIGS. 5A-5C illustrate three sets of target stress-strain curves in accordance with embodiments of the present invention. In FIG. 5A, the set of curves 501-503 represents the tailorability of the tangent modulus. In FIG. 5B, the set of curves 504-506 represents that of the first peak stress and subsequent negative stiffness. In FIG. 5C, the set of curves 507-509 represents that of the second peak stress. 3D digital models 511-519 in FIGS. 5A-5C represent compound lattices inversely designed by the ML-predicted design gradients for the target curves 501-509 (e.g., 3D digital model 511 corresponds to target curve 501, digital model 512 corresponds to target curve 512, etc.). Respective coefficients of variance 521-529 characterize the spread of the corresponding design gradients.

FIGS. 5A-5C demonstrate the inverse design of advanced curve features. As an example, three sets of stress-strain curves may be fed into the ML pipeline separately, where each set focuses on separately tailoring tangent modulus (curves 501, 502 and 503), first peak stress (curves 504, 505, and 506), and second peak stress (curves 507, 508 and 509). The corresponding inversely designed 3D digital models describing compound lattices (511-513, 514-516, and 517-519, respectively) and the spreads of their gradient labels (G1-G4) describing the variation of the gradient labels within the lattice in terms of the coefficient of variance (COV) (521-523, identified by legend 570, 524-526, identified by legend 572, and 527-529, identified by legend 574) are also presented in the figure. The ML-predicted results reveal that manipulating pairs of gradient labels independently modulate advanced curve features, including multiple peak stresses and signs of the tangent modulus, allowing for fine control of a variety of sectioned stress-strain curves (FIG. 5A-C). For example, in the case of tuning tangent modulus (FIG. 5A), there was negligible variation in unit cell (G1) and strut radius ratio (G2) gradients, indicating the sign of the tangent modulus is mainly controlled by a combination of the inclined strut radius (G3) and unit cell size (G4) gradients. Similarly, G1 and G2 together modulated the first peak stress (FIG. 5B). Additionally, in the case of tuning second peak stress (FIG. 5C), significant variation in G2 was observed while the other three gradients remained almost the same, indicating G2 were mainly responsible for the second peak stress manipulation.

FIGS. 5D-5F are an experimental demonstration of tailored stress-strain hysteresis loops displaying deformations at different strains in accordance with embodiments of the present invention. The stress-strain hysteresis loop 532 in FIG. 5D was tailored to a loop 542 exhibiting negative stiffness in FIG. 5E and further tailored to a loop 552 exhibiting multiple stress peaks in FIG. 5F. The target curves (534, 544, 546) and photographs (536, 546, 556) of the as-fabricated, ML-designed compound lattices are shown.

Employing the present invention resulted in experimentally measured target curves (534, 544, 554) and the primary graphs (530, 540, 550) show the recreated stress-strain curves (532, 542, 552) of the predicted designs (536, 546, 556). As demonstrated by FIG. 5D, in embodiments, for the target curve 534 with a nearly zero tangent modulus, the predicted gradient labels indicated minimal variation, and homogeneous deformation of a designed compound lattice was observed. Next, as shown in FIG. 5E, target curve 544 was tailored to exhibit a negative tangent modulus after the first peak. The measured mechanical behavior 542 reveals localized nonaffine deformation and corroborates the role of the gradient labels discussed earlier; the first peak stress was dominated by G1 and G2, followed by a subsequent shifting/snapping event with a negative tangent modulus controlled by G3 and G4. In embodiments, as shown in FIG. 5F, the target curve 554 shown may be further tailored to contain a second peak stress, while keeping all preceding curve features, as depicted by the measured curve 552. The predicted gradient labels included a change in G2 (~50%) substantially different from that of the former lattice shown in FIG. 5E, confirming the role of this gradient in peak stress manipulation.

An advantage of embodiments of the present invention is that these advanced, inversely designed stress-strain curves featuring successive peak stresses and coordinated collapse mechanisms together with tailored softening effects may make the inversely designed compound lattice (e.g., as printed in model 556) shown in FIG. 5F an excellent candidate for ML-designed custom padding materials for energy absorption. In experimental embodiments, drop tests conducted on the sample revealed that the measured acceleration and potential energy due to impact were reduced by ~30% and ~25%, respectively, as a result of the compound lattice. In experiments, the compound lattice achieved energy absorbing performance outperforming that of previously reported lattice materials [34-40].

### Sample Fabrication

In embodiments, lattices may be created as 3D digital models using commercial computer-aided design (“CAD”) software (e.g., Autodesk Inventor 2022). Different base material may be used in modelling and in fabrication. For example, in embodiments, two distinct base materials may be used for fabrication, where each base material is assigned to a unique dataset. In embodiments, a brittle base material, denoted by TMPTA, includes a photosensitive resin consisting of trimethylolpropane triacrylate (Sigma-Aldrich Inc., St. Louis, MO) with 0.0125 wt % photoabsorber and 2 wt % phenylbis(2,4,6-trimethylbenzoyl) phosphine oxide photoinitiator (Sigma-Aldrich Inc., St. Louis, MO). In embodiments, a flexible base material includes a commercial resin (e.g., Flexible 80A, Formlabs Inc., Somerville, MA). In embodiments, a digital light 3D printer (e.g., Anycubic Photon S, Anycubic Inc., Shenzhen, China) is used to fabricate brittle samples using TMPTA. In embodiments, a customized projection stereolithography system may be built and used for printing flexible samples. In embodiments, a number of samples (e.g., at least three samples) for each model are tested during a validation process. In embodiments, once fabricated, all samples are cleaned (e.g., with ethanol and dried in a dark environment for 24 hours).

### Experimental Testing

Experimental testing was performed to verify the effectiveness of the present invention. All compression tests were performed by using the Instron 5944 universal testing machine (Instron Corporation, Norwood, MA). The printed lattice samples were compressed between the stationary and moving steel plates of the Instron 5944 universal testing machine. The loads were measured by the Instron load cell with a load capacity of 2000 N (serial no.: 150821), and the displacements were measured by the built-in encoder associated with the crosshead movement. For the monotonic compression test, stress-strain curves of the samples were recorded up to the onset of the first appearance of failure. For the cyclic compression test, hysteresis loops with three different strain levels were recorded while ensuring elastic recovery of the samples. Stress was computed as the measured load divided by the effective area (Llattice)², and strain was calculated as the displacement divided by Llattice, where Llattice refers to the side length of the sample.

Drop tests were performed by dropping a dead weight (mass m of 500 g) onto the test samples from different heights, h. The sample size used in the drop tests was nominally 60×60×60 mm³ in volume. The drop height was between 50 and 150 mm to measure energy absorption while preventing damage to the test samples. The impact force was recorded by a force transducer fixed directly underneath the bottom of a flat, rigid steel plate. The transmitted force was measured in a similar manner but with the sample fixed on the top of the rigid plate. Both measurements were taken at a sampling rate of 100 Hz using the Instron data acquisition hardware. Impact acceleration was calculated using Newton's second law, a=F/m, where F is the measured force and m is the mass of the dead weight. The potential energy was computed as P=Fh.

### ML Model Setups and Evaluation

In embodiments, the ML models in the inverse prediction module and forward validation module may be implemented using NN models (e.g., a generative model and surrogate model, respectively) on software (e.g., Python 3.7). During training, hyperparameter settings for all models may be optimized by a stochastic gradient descent (SGD) optimizer. In experimental testing, through a 10-fold cross-validation technique with all training data instances (equivalent to a training/testing split ratio of 70:30 with interchangeable switching of the training and testing sets), the ML models built with optimized hyperparameters showed a prediction accuracy of ~90 percent on average.

### Sequential Integration Strategy for Compound Lattice Prediction

FIGS. 11A and 11B depict a sequential integration strategy for compound lattice generation and training set generation in accordance with exemplary embodiments of the present invention. In embodiments, a number of compound lattices are generated within a specified domain for training dataset generation. In embodiments, the stress-strain curves generated in response to a quasi-static, monotonic compression are estimated by using simulations. As depicted in FIG. 11A, each simulated curve may then be digitized into 46 curve features and used as the input data of the ML model. In embodiments the machine learning model generates four predicted design gradients 1120 for each curve, for example, unit cell topology 1122 (G₁), strut radius ratio 1124 (G₂), inclined strut radius 1126 (G₃), and unit cell size 1128 (G₄).

In embodiments, as depicted in FIG. 11B, a sequential integration strategy 1130 is adopted for inverse design of compound lattices (i.e., lattices with dissimilar unit cells), where a subset of previously predicted design gradients may be utilized as part of the input in subsequent prediction stages. Specifically, in embodiments, in the first step of training of the ML model comprising two classifiers (e.g., topology classification 1132 and unit cell size classification 1138) and two regressors (e.g., strut radius ration regression 1134 and inclined strut radius regression 1136), the unit cell gradient (G₁) is first be estimated via a classifier (e.g., topology classification 1132) for curve features {X} (e.g., features 1110) parameterized from a target stress-strain curve. In embodiments, a compound descriptor combining {X} and the predicted G1 is then used to determine the strut radius ratio gradient (G₂) via regression (e.g., strut radius ration regression 1134). In embodiments, a subsequent regression task (e.g., inclined strut radius regression 1136) is then performed to estimate the inclined strut radius gradient (G₃) using another compound descriptor combining {X} and the predicted G₁ and G₂. As the last step, the unit cell size gradient (G₄) may be classified by using a compound vector composed of {X} and the predicted G₁, G₂ and G₃ (e.g., unit cell size classification 1138). This exemplary embodiments process follows steps (i) through (iv): (i) C1(X)→G1; (ii) R1(X, G1)→G2; (iii) R2(X, G1, G2)→G3; and (iv) C2(X, G1, G2, G3)→G4, where C and R denote classification and regression, respectively.

In embodiments, as shown in FIG. 11B, the output of the modified sequential integrated ML strategy for inverse design of compound lattices (e.g., the design gradients G₁, G₂, G₃, and G₄) is compressed. In particular, in embodiments, matrices and vectors representing the design gradients associated with a compound lattice are compressed into a 1×82 compressed vector. In embodiments, each of the topology-gradient (G₁), the strut radius ratio-gradient (G₂), the inclined strut radius-gradient (G₃), represented by the 3×3×3 matrix representation, are first converted into a 1×27 vector. In embodiments, The unit cell size gradient (G₄) is described by the 1×3 vector representation denoting the four sequence-independent possibilities varying from 1 to 4. In embodiments, the vectors/classifier(s) are then compressed together to form a 1×82 vector.

Referring back to FIG. 11A, in embodiments, a predicted and/or inversely designed compound lattice may be superposed with the predicted design gradients 1120 to form an inversely designed compound lattice 1150. In embodiments, the inversely designed compound lattice 1150 includes distinct cell types, such as cell type 1152 (A), 1154 (B) and 1156 (C). In embodiments, the inversely design compound lattice 1150 is then printed and tested. In embodiments, the test results are used to generate achieved response 1114. In embodiments, the training set for the machine learning model is generated or augmented using features 1110 of the target response 1112, the achieved response 1114, other aspects of the achieved response and target response, and evaluations of the achieved response 1114 in relation to the target response 1112 (such as determining dissimilarity using a normalized root mean square error calculation). In embodiments, evaluations are based on one or more features. In embodiments, evaluations are based on the entirety of the curves. In embodiments, the inversely designed compound lattice may be tagged based on evaluations. In embodiments, one or more predicted design gradients may be tagged based on evaluations.

### Finite Element (FE) Simulations

In embodiments, FE simulations of the stress-strain curves of lattices may be conducted using ABAQUS 6.14. Lattices at low- and mid-relative densities (ρ̅≤0.15) may be discretized using 2-node linear Timoshenko beam elements (B31 of ABAQUS), whereas second-order tetrahedral elements (C3D10M of ABAQUS) may be used to discretize lattices at higher relative densities (ρ̅≥0.15), in part because the beam element may not be capable of accurately describing the warping of cross-section of stubby struts whereas 3D stress element is more able to precisely capture the deformation of the lattices with high relative densities [42]. In embodiments, each strut may be modeled by between 15 and 30 elements depending on its length. Each lattice may be compressed between a fixed and a moving, flat, rigid surface discretized by rigid bilinear quadrilateral elements (R3D4 of ABAQUS). In embodiments, an explicit solver may be used while keeping the kinetic energy less than 1% of the total internal energy to ensure a quasistatic loading condition. A 10% percentage of mode shapes (eigenmodes) of the lattice may be applied to the simulation to prevent bifurcation issue at the buckling point, which in some circumstance may cause non-convergence solution in the numerical analysis. Contact effects may be modeled using a hard contact behavior for the normal direction and finite sliding in the tangential direction with a coefficient of friction of 0.8. In embodiments, for the constituent material models, TMPTA, used to create periodic lattices, may be modeled as an elastic-plastic material (a short plastic region after linear-elastic region representing brittle fracture) with isotropic hardening, Poisson's ratio vs of 0.3, and a fracture strain of 0.044. Formlabs Flexible, used to create compound lattices, may be modeled as a linear elastic material with Poisson's ratio vs of 0.48 and a fracture strain of 0.424. Experimental testifying verified these exemplary material models by the measured tensile response of the dogbone test samples printed with such base materials.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

### REFERENCES

[1] Lakes, R. Foam structures with a negative Poisson's ratio. Science 235, 1038-1041 (1987).
[2] Prall, D. & Lakes, R. Properties of a chiral honeycomb with a Poisson's ratio of −1. Int. J. Mech. Sci. 39, 305-314 (1997).
[3] Buckmann, T. et al. On three-dimensional dilational elastic metamaterials. New J. Phys. 16, 033032 (2014).
[4] Grima, J., Attard, D. & Gatt, R. Truss-type systems exhibiting negative compressibility. Phys. Status Solidi B 245, 2405-2414 (2008).
[5] Lakes, R. & Wojciechowski, K. Negative compressibility, negative Poisson's ratio, and stability. Phys. Status Solidi B 245, 545-551 (2008).
[6] Bauer, J. et al. Push-to-pull tensile testing of ultra-strong nanoscale ceramic-polymer composites made by additive manufacturing. Extreme Mech. Lett. 3, 105-112 (2015).
[7] Zheng, X. et al. Multiscale metallic metamaterials. Nat. Mater. 15, 1100-1106 (2016).
[8] Meza, L., Das, S. & Greer, J. Strong, lightweight, and recoverable three-dimensional ceramic nanolattices. Science 345, 1322-1326 (2014).
[9] Shan, S. et al. Multistable architected materials for trapping elastic strain energy. Adv. Mater. 27, 4296-4301 (2015).
[10] Ha, C., Lakes, R. S. & Plesha, M. E. Cubic negative stiffness lattice structure for energy absorption: Numerical and experimental studies. Int. J. Solids Struct. 178-179, 127-135 (2019).
[11] Wehmeyer, S. et al. Post-buckling and dynamic response of angled struts in elastic lattices. J. Mech. Phys. Solids 133, 103693 (2019).
[12] Bauer, J., Schroer, A., Schwaiger, R. & Kraft, O. Approaching theoretical strength in glassy carbon nanolattices. Nat. Mater. 15, 438-443 (2016).
[13] Chen, D., Zhu, M. & Matusik, W. Computational discovery of extremal microstructure families. Sci. Adv. 4, eaao 7005 (2018).
[14] Xia, L. & Breitkopf, P. Concurrent topology optimization design of material and structure within FE2 nonlinear multiscale analysis framework. Comput. Methods in Appl. Mech. Eng. 278, 524-542 (2014).
[15] Takezawa, A. & Kobashi, M. Design methodology for porous composites with tunable thermal expansion produced by multi-material topology optimization and additive manufacturing. Compos. B. Eng. 131, 21-29 (2017).
[16] Gu, G., Chen, C., Richmond, D. & Buehler, M. Bioinspired hierarchical composite design using machine learning: simulation, additive manufacturing, and experiment. Mater. Horiz. 5, 939-945 (2018).
[17] Bessa, M., Glowacki, P. & Houlder, M. Bayesian machine learning in metamaterial design: fragile becomes supercompressible. Adv. Mater. 31, 1904845 (2019).
[18] Bock, F. E. et al. A review of the application of machine learning and data mining approaches in continuum materials mechanics. Frontiers in Materials 6, 110 (2019).
[19] Kumar, S., Tan, S., Zheng, L. & Kochmann, D. Inverse-designed spinodoid metamaterials. Npj Comput. Mater. 6, 1-10 (2020).
[20] Wilt, J., Yang, C. & Grace, G. Accelerating Auxetic Metamaterial Design with Deep Learning. Adv. Eng. Mater., 1901266 (2020).
[21] Mao, Y., He, Q. & Zhao, X. Designing complex architectured materials with generative adversarial networks. Science advances 6, eaaz4169 (2020).
[22] Garland, A. P., White, B. C., Jensen, S. C. & Boyce, B. L. Pragmatic generative optimization of novel structural lattice metamaterials with machine learning. Materials & Design 203, 109632 (2021).
[23] Sigmund, O. & Maute, K. Topology optimization approaches. Struct. Multidiscipl. Optim. 48, 1031-1055 (2013).
[24] Zargham, S., Ward, T. A., Ramli, R. & Badruddin, I. A. Topology optimization: a review for structural designs under vibration problems. Struct. Multidiscipl. Optim. 53, 1157-1177 (2016).
[25] Pasini, D. & Guest, J. K. Imperfect architected materials: mechanics and topology optimization. MRS Bulletin 44, 766-772 (2019).
[26] Moussa, A., Melancon, D., El Elmi, A. & Pasini, D. Topology optimization of imperfect lattice materials built with process-induced defects via Powder Bed Fusion. Additive Manufacturing, 101608 (2020).
[27] Hashin, Z. & Shtrikman, S. A variational approach to the theory of the elastic behaviour of multiphase materials. Journal of the Mechanics and Physics of Solids 11, 127-140 (1963).
[28] Suquet, P. Overall potentials and extremal surfaces of power law or ideally plastic composites. Journal of the Mechanics and Physics of Solids 41, 981-1002 (1993).
[29] Mazur, M. et al. Deformation and failure behaviour of Ti-6Al-4V lattice structures manufactured by selective laser melting (SLM). The International Journal of Advanced Manufacturing Technology 84, 1391-1411 (2016).
[30] Liu, L., Kamm, P., Garcia-Moreno, F., Banhart, J. & Pasini, D. Elastic and failure response of imperfect three-dimensional metallic lattices: the role of geometric defects induced by Selective Laser Melting. Journal of the Mechanics and Physics of Solids 107, 160-184 (2017).
[31] Hitzler, L. et al. On the anisotropic mechanical properties of selective laser-melted stainless steel. Materials 10, 1136 (2017).
[32] Xiao, Z. et al. Evaluation of topology-optimized lattice structures manufactured via selective laser melting. Materials & Design 143, 27-37 (2018).
[33] Henning, E. & Milani, T. In-shoe pressure distribution for running in various types of footwear. J. Appl. Biomech. 11, 299-310 (1995).
[34] Schaedler, T. et al. Designing Metallic Microlattices for Energy Absorber Applications. Adv. Eng. Mater. 16, 276-283 (2014).
[35] Lai, C. & Daraio, C. Highly porous microlattices as ultrathin and efficient impact absorbers. Int. J. Impact Eng. 120, 138-149 (2018).
[36] Frenzel, T., Findeisen, C., Kadic, M., Gumbsch, P. & Wegener, M. Tailored buckling microlattices as reusable light-weight shock absorbers. Adv. Mater. 28, 5865-5870 (2016).
[37] Correa, D. et al. Negative stiffness honeycombs for recoverable shock isolation. Rapid Prototyp. J. 21, 193-200 (2015).
[38] Maskery, I. et al. An investigation into reinforced and functionally graded lattice structures. J. Cell. Plast. 53, 151-165 (2017).
[39] Chen, S. et al. Elastic carbon foam via direct carbonization of polymer foam for flexible electrodes and organic chemical absorption. Energy Environ. Sci. 6, 2435-2439 (2013).
[40] Moss, W. & King, M. Impact response of US Army and National Football League helmet pad systems. (Lawrence Livermore National Lab CA, 2011).
[41] Pan, S. & Yang, Q. in IEEE Transactions on knowledge and data engineering. 1345-1359.
[42] Nikula, S., Matikainen, M. K., Bozorgmehri, B. & Mikkola, A. The usability and limitations of the various absolute nodal coordinate beam elements subjected to torsional and bi-moment loading. European Journal of Mechanics-A/Solids 97 (2023). https://doi.org: 10.1016/j.euromechsol.2022.104824
[43] Gibson, I. & Ashby, M. F. The mechanics of three-dimensional cellular materials. Proceedings of the royal society of London. A. Mathematical and physical sciences 382, 43-59 (1982).
[44] Oliphant, T. A guide to NumPy. (Trelgol Publishing USA, 2006).
[45] Virtanen, P. et al. SciPy 1.0: fundamental algorithms for scientific computing in Python. Nat. Methods 17, 261-272 (2020).
[46] Mckinney, W. pandas: a foundational Python library for data analysis and statistics. Python for High Performance and Scientific Computing 9, 14 (2011).
[47] Schutt, K. et al. How to represent crystal structures for machine learning: Towards fast prediction of electronic properties. Phys. Rev. B 89, 205118 (2014).
[48] Savitzky, A. & Golay, M. Smoothing and differentiation of data by simplified least squares procedures. Anal. Chem. 36, 1627-1639 (1964).

What is claimed is:

1. A method for designing and generating a target with customizable architecture including:
a) obtaining, by a first machine learning module, a set of target stress-strain curve features characterizing a target stress-strain curve;
b) generating a first output, by the first machine learning module trained using a first training set, based on a first query, wherein:
i) the first query includes the set of target stress-strain curve features;
ii) the first output includes sets of digital design parameters for printing the metamaterial target using a 3D printer, wherein each of the sets of digital design parameters includes:
1) for each cell, a cell type denoting a category of unit cell, and a characteristic angle specifying an orientation of struts of each cell in the category, and a radius-to-length ratio of an inclined strut representing the solid-to-air ratio of the unit cell; and
2) a design lattice structure utilizing each cell; and
3) a base material type; and
4) a gradient; and
iii) the first training set includes a first plurality of training stress-strain curve features and respective associated design parameters sets;
c) obtaining, by a second machine learning module, the sets of digital design parameters;
d) obtaining, by the second machine learning module, a subset of the set of target stress-strain curve features;
e) generating a second output, by the second machine learning module trained using a second training set, based on a second query, wherein:
i) the second query includes the sets of digital design parameters and the subset of the set of target stress-strain curve features;
ii) the second output includes respective sets of stress-strain curve features characterizing a predicted stress-strain curve;
iii) the second training set includes a second plurality of training stress-strain curve features and respective associated design parameters sets;
f) determining, by the second machine learning module, an optimal set of design parameters of the sets of digital design parameters; and
g) printing or causing to print, by a 3D printer, the metamaterial target, based on the optimal set of design parameters.

2. The method of claim 1, wherein the target stress-strain curve is a user-defined target stress-strain curve.

3. The method of claim 2, wherein the user-defined target stress-strain curve is drawn by a user.

4. The method of claim 2, wherein the user-defined target stress-strain curve is uploaded by a user.

5. The method of claim 2, wherein the user-defined target stress-strain curve is input by a user.

6. The method of claim 1, wherein the sets of digital design parameters are transmitted from the first machine learning module to the second machine learning module.

7. The method of claim 1, wherein the subset of the set of target stress-strain curve features includes one or more features corresponding to load type.

8. The method of claim 1, wherein the first machine learning module includes an inverse prediction module.

9. The method of claim 1, wherein the second machine learning module includes a forward validation module.

10. The method of claim 9, wherein the forward validation module includes a curve type classifier and a curve feature regressor.

11. The method of claim 1, wherein the printing step is further based on printing parameters.

12. The method of claim 11, wherein the printing parameters include a minimum feature size and a maximum print volume of the 3D printer.

13. The method of claim 1, wherein the base material type may be selected from a list of materials.

14. The method of claim 1, wherein the first training set includes data augmented from a pristine data.

15. The method of claim 1, wherein the second training set includes pristine data.

16. The method of claim 1, wherein the second plurality of training stress-strain curve features and respective associated design parameters sets includes a subset of the first plurality of training stress-strain curve features and respective associated design parameters.

17. The method of claim 1, wherein the generating step e) is iterated.

18. The method of claim 1, wherein the method is iterated based on testing of the target.

19. The method of claim 1, wherein the target is a metamaterial target.

20. The method of claim 1, wherein the optimal set of design parameters is the set of design parameters associated with the lowest normalized root mean square error between the predicted stress-strain curve and the target stress strain curve.

21. (canceled)
